(19) United States
(12) Patent Application Publication
(10) Pub. No.: US 2018/0018615 A1
(43) Pub. Date: Jan. 18, 2018

(54) System and Method for Management of Variable Staffing and Productivity

(71) Applicant: Stafficiency Inc., Fort Mitchell, KY (US)

(72) Inventors: Micha R. Crowley, Columbia, MO (US); William R. Adams, Ft. Mitchell, KY (US)

(21) Appl. No.: 15/211,121

(22) Filed: Jul. 15, 2016

(51) Int. Cl. G06Q 10/06

(52) U.S. Cl. CPC G06Q 10/063118; G06Q 10/063112; G06Q 10/063116

(57) ABSTRACT

Systems and methods are disclosed for management of variable staffing. In an example system, a processor determines a staffing solution based on user-selected attributes including a number and/or identity of persons assigned to each personnel category for each employment unit, based on staffing guidelines (determined based on a patient census) comprising a suggested number of staff personnel for each personnel category for each employment unit, based on available personnel, and based on a variance for each staff personnel category associated with each employment unit, the variance representing a difference between a guideline number of staff personnel and an available number of personnel. The processor further generates and displays a graphical user interface displaying information comprising at least one of the attributes, guidelines, available personnel, selected personnel, and variances, and provides utilities to receive user input to implement changes.

### FIELD OF THE INVENTION

This disclosure generally relates to solutions for variable staffing and productivity management.

### BACKGROUND OF THE INVENTION

Conventional methods for managing variable staffing and productivity for large organizations are generally inefficient, especially for organizations having variable workloads that require staff to be increased or decreased on a regular basis in response to unpredictable changes in workload. In a hospital, for example, the number and type of staff personnel required depends on the number of patients and the type of treatment each patient requires. In a large organization, such as a hospital that has many departments with differing staffing needs, it is generally not possible using conventional approaches to effectively manage, communicate, and archive variable staffing decisions that are made by a variety of management and supervisory personnel. For example, a hospital that is overstaffed wastes money paying staff members that are not needed, while an understaffed hospital may yield overworked staff members that struggle to properly provide all the care that each patient may need or desire. Additionally, it is often difficult to access and data associated with prior staffing and staffing decisions in order to be used for productivity management or quality improvement.

### SUMMARY OF THE INVENTION

The disclosed embodiments provide a solution to the above-referenced problems based on a computerized variable staffing and productivity management system that allows management to rapidly meet staffing needs and communicate staffing information in an efficient manner. The disclosed systems and methods are based on a team approach that allows information to be disseminated quickly, getting information to the right people at the right time so that staffing decisions may be made quickly and efficiently. The disclosed embodiments utilize a variance as a metric to characterize a staffing situation as optimal (having zero variance), overstaffed (positive variance), or understaffed (negative variance). An efficient staffing scenario is achieved by decreasing staff from overstaffed units and increasing staff in understaffed units so as to minimize the absolute value of an aggregate variance for the organization and increase productivity. The disclosed systems further provide detailed reporting utilities to gather and document organization-wide data that is accessible and is useful for budgetary planning and forecasting.

According to an embodiment, systems and methods are disclosed for generating an employment staffing management system. An example system includes one or more processors and at least one memory. The memory has computer program instructions stored thereon that, when executed by the processor, cause the processor to perform operations for generating an employment staffing management system, according to an embodiment.

In a first stage, the instructions executed by the processor cause the processor to determine attributes for a plurality of employment units, each unit having a plurality of staff personnel categories. According to an embodiment, the attributes include a number and identity of persons assigned to each personnel category for each employment unit.

In a second stage, the instructions executed by the processor cause the processor to calculate staffing guidelines comprising a suggested number of staff personnel for each personnel category for each employment unit. In a further stage, the processor is configured to determine a list of available personnel that may be assigned to personnel categories for each employment unit.

In a further stage, the processor is configured to receive input from a user input device, the input designating a user selection of an employment unit and/or a designation of one or more persons to be assigned to a staff personnel category associated with a selected employment unit.

In a further stage, the processor is configured to calculate a variance for each staff personnel category associated with each employment unit, the variance representing a difference between a selected number of staff personnel and an available number of personnel or the variance representing a difference between a guideline number of staff personnel and an available number of personnel.

In a further stage, the processor is configured to generate and display a graphical user interface on a display device, the graphical user interface displaying information comprising the attributes, guidelines, available personnel, selected staff personnel, and variances. According to an embodiment, the information may be presented on one or more user-selectable screens and/or menus that provide utilities for the information to be changed in response to user input.

Once a number of selections have been received, a test is performed to determine whether or not all selections have been made. If a user has not finished making selections, the method continues to allow a user to make further selections for additional staff personnel categories associated with other employment units. The processor generates staffing and productivity information based on the attributes when it has been determined that the user has finished making selections.

Further embodiments, features, and advantages, as well as the structure and operation of the various embodiments, are described in detail below with reference to the accompanying drawings.

### BRIEF DESCRIPTION OF THE DRAWINGS

Embodiments are described with reference to the accompanying drawings. In the drawings, like reference numbers may indicate identical or functionally similar elements.

FIG. 1 is a schematic illustration of an example system for generating an employment staffing solution, according to an embodiment.

FIG. 2 is a schematic illustration of an example graphical user interface as it may be displayed on a display device, according to an embodiment.

FIG. 3 is a schematic illustration of the graphical user interface of FIG. 2 in a configuration in which the telemetry employment unit has been selected, according to an embodiment.

FIG. 4 is a schematic illustration of a pop-up window providing a drag-and-drop utility for selecting staff personnel to be assigned as available staff, according to an embodiment.

FIG. 5 is a schematic illustration of the pop-up window of FIG. 4 in a state in which staff members have been selected, according to an embodiment.

FIG. 6 is a schematic illustration of the pop-up window of FIG. 5 in a state in which staff members that have been selected have been dragged to the destination area, according to an embodiment.

FIG. 7 is a schematic illustration of the updated census screen as it appears after staff members have been selected using the drag-and-drop pop-up selection window of FIGS. 4-6, according to an embodiment.

FIG. 8 is a schematic illustration of the updated census screen as it appears after staff members for three employment categories have been selected and saved using the drag-and-drop pop-up selection window of FIGS. 4-6, according to an embodiment.

FIG. 9 is a schematic illustration of a first configuration of the worksheet page, according to an embodiment.

FIG. 10 is a schematic illustration of a second configuration of the worksheet page, according to an embodiment.

FIG. 11 is a schematic illustration of a third configuration of the worksheet page, according to an embodiment.

FIG. 12 is a schematic illustration showing the result of the use of a drag-and-drop utility to increase the number of available staff starting with the configuration of the worksheet page of FIG. 11, according to an embodiment.

FIG. 13 is a schematic illustration of a fourth configuration of the worksheet page, according to an embodiment.

FIG. 14 is a schematic illustration of a drag-and-drop pop-up window used to select available staff personnel for the NA category of the float pool, according to an embodiment.

FIG. 15 is a schematic illustration of a drag-and-drop pop-up window used to select available staff personnel for the nurse category of the float pool, according to an embodiment.

FIG. 16 is a schematic illustration showing changes to the float pool due to the drag-and-drop processes of FIGS. 14 and 15, according to an embodiment.

FIG. 17 is a schematic illustration showing further details for the drag-and-drop “call in extra” and “flex off” utilities, according to an embodiment.

FIG. 18 is a schematic illustration showing the use of a drag-and-drop pop-up window used to remove available staff personnel using the “flex off” utility, according to an embodiment.

FIG. 19 is a schematic illustration of a fifth configuration of the worksheet page showing a list of changes, according to an embodiment.

FIG. 20 is a schematic illustration of the census page showing changes awaiting confirmation for the telemetry unit, according to an embodiment.

FIG. 21 is a schematic illustration of the census page showing a visual indicator that changes for the telemetry unit have been confirmed, according to an embodiment.

FIG. 22 is a schematic illustration of the census page showing a situation in which a warning is given that certain variances are non-zero, according to an embodiment.

FIG. 23 is a schematic illustration of the census page showing a visual indicator that changes for the northside 3NW unit, including non-zero variances, have been confirmed, according to an embodiment.

FIG. 24 is a schematic illustration of a utility having a pop-up window for specifying reasons for non-zero variances, according to an embodiment.

FIG. 25 is a schematic illustration of the utility of FIG. 24 having a pop-up window with selected reasons given for non-zero variances, according to an embodiment.

FIG. 26 is a schematic illustration of the dashboard page that provides a summary of schedule settings implemented on the census and worksheet pages, according to an embodiment.

FIG. 27 is a schematic illustration of the reports page that provides a summary of schedule settings implemented on the census and worksheet pages, according to an embodiment.

FIG. 28 is a flowchart illustrating a method of generating a staffing solution, according to an embodiment.

FIG. 29 is a block diagram of an example computer system in which embodiments of the disclosed invention, or portions thereof, may be implemented as computer-readable code, which is executed by one or more processors, according to an embodiment.

### DETAILED DESCRIPTION

This disclosure provides systems and methods for managing of variable staffing systems and evaluating productivity for large organizations that have rapidly changing workflow demands. The disclosed systems further provide detailed reporting utilities that gather and document organization-wide data that is useful for budgetary planning and forecasting.

Reference in this specification to “one embodiment,” “an embodiment,” an “example embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one of ordinary skill in the relevant art to affect such feature, structure, or characteristic in connection with other embodiments whether or not explicitly described.

The following detailed description refers to the accompanying drawings that illustrate exemplary embodiments. Other embodiments are possible, and modifications can be made to the embodiments within the spirit and scope of this description. Those of ordinary skill in the relevant art with access to the teachings provided herein will recognize additional modifications, applications, and embodiments within the scope thereof and additional fields in which embodiments would be of significant utility. Therefore, the detailed description is not meant to limit the embodiments described below.

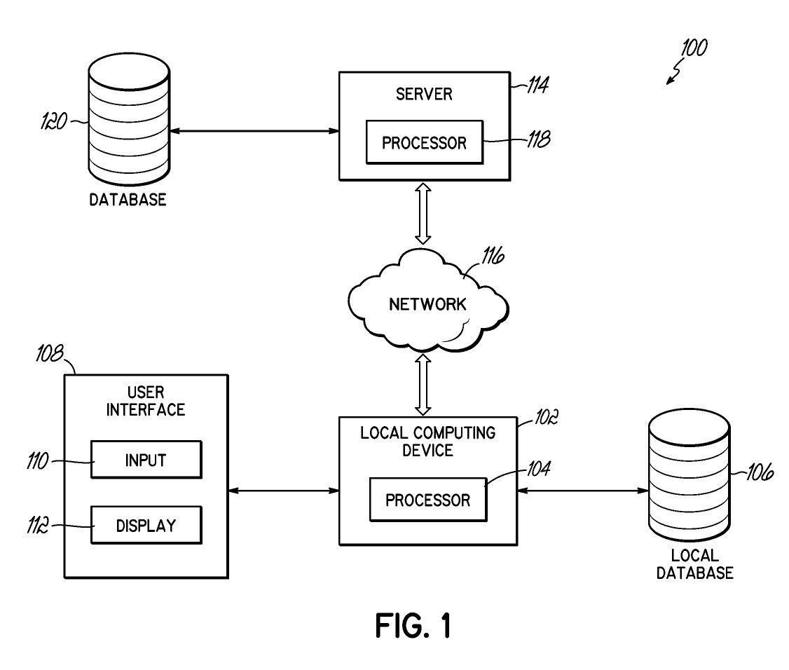

FIG. 1 is a schematic illustration of an example system 100 for management of variable staffing and productivity, according to an embodiment. The system may include a local computing device 102 such as a workstation, a laptop computer, a mobile computing device such as a smart phone, etc. The local computing device 102 may have a processor 104 and a memory 106 including a local data base. The memory may further comprise computer program instructions that, when executed by the processor 104, cause the processor to perform operations related to the disclosed invention. The local computing device may further comprise a user interface 108. The user interface 108 may include a keyboard, a touch screen, or other user input device 110. The user interface 108 may further include a display device 112.

According to an embodiment, the system my further include a server 114. The local computing device 102 may interact with the server 114 and exchange data with the server 114 through a network 116. The server 114 may further include a processor 118 and a memory 120 including a database. The database included in the memory 120 my include computer program instructions that, when executed by the processor 118, cause the processor to perform operations associated with the disclosed invention. For example, the computer program instructions may cause the processor to interact with the network 116 and to communicate with the local computing device 102. The local computing device 102 and the server 114 may communicate via the network 116 to cooperatively perform operations associated with the disclosed invention, as described in further detail below. In further embodiments, the operations associated with the invention may be performed by the local computing device 102 in a stand-alone fashion without communicating with the server 114.

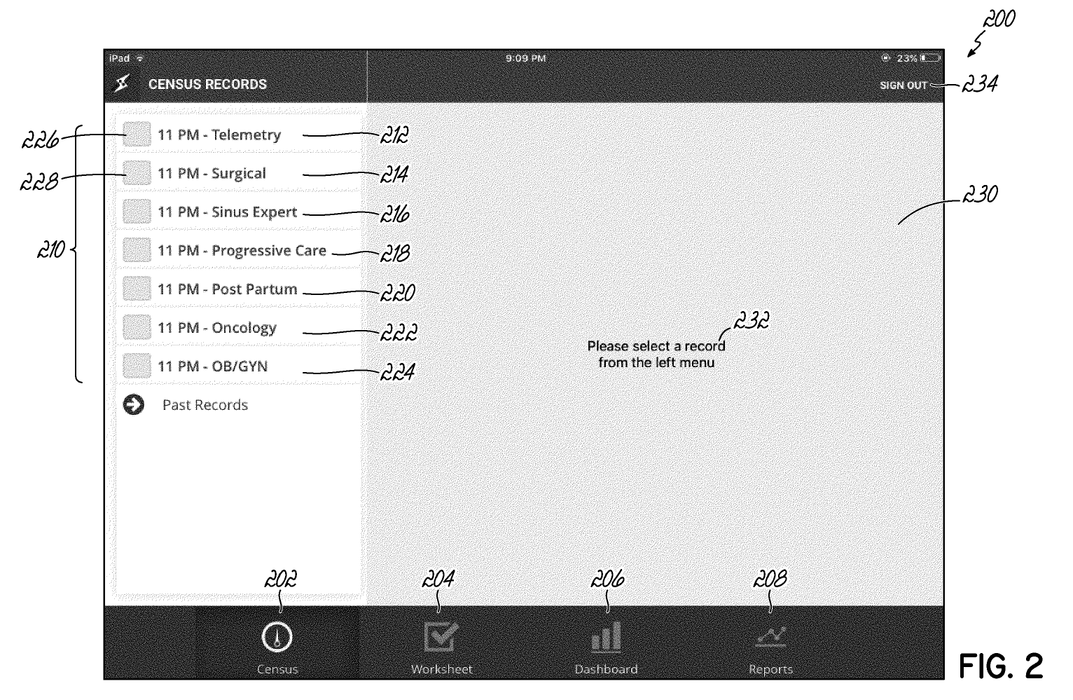

FIG. 2 is a schematic illustration of an example graphical user interface (GUI) 200 as it may be displayed on a display device, according to an embodiment. In this example, the system is configured to manage variable staffing scenarios and productivity for a hospital. In further embodiments, the system may be configured to manage variable staffing scenarios and productivity for another employment organization as would be readily apparent to persons of ordinary skill in the art.

The GUI 200 may be configured to display information on a number of user-selectable pages. In this example, the user-selectable pages may include a census page, a worksheet page, a dashboard page, and a reports page. The census page may be selected by selecting a button 202 associated with the census page. According to an embodiment, the button 202 may be displayed on a computer touch screen display device. In this example, the button 202 may be selected by a user upon touching the button 202 on the touch screen display device. In a further embodiment, the button 202 may be displayed on the GUI 200 and may be selected by a user through manipulation of a mouse or other mechanical user input device. In further embodiments, the button 202 may be implemented as a mechanical button which selects the census page when a user imparts a mechanical motion to the button 202. Details of the census page are described below with references to FIGS. 2-8 and 20-25.

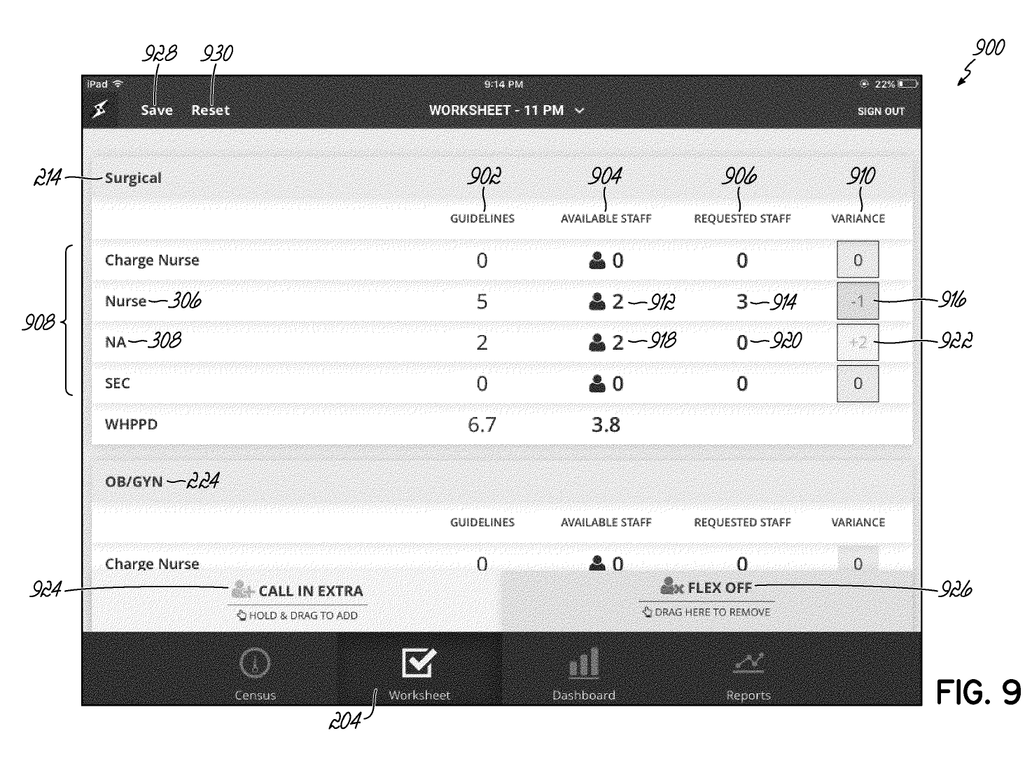

According to an embodiment, the worksheet page may be selected by selecting button 204. As described above, the button 204 may be displayed on a standard display device and may be selected through user interaction with a user input device. In further embodiments, button 204 may be displayed on touch screen display and may be selected when a user touches button 204 on the touch screen display. Further, button 204 may be implemented as a mechanical button which selects the census page when a user imparts a mechanical motion to the button 204. Details of the worksheet page are described in further detail below with reference to FIGS. 9-19.

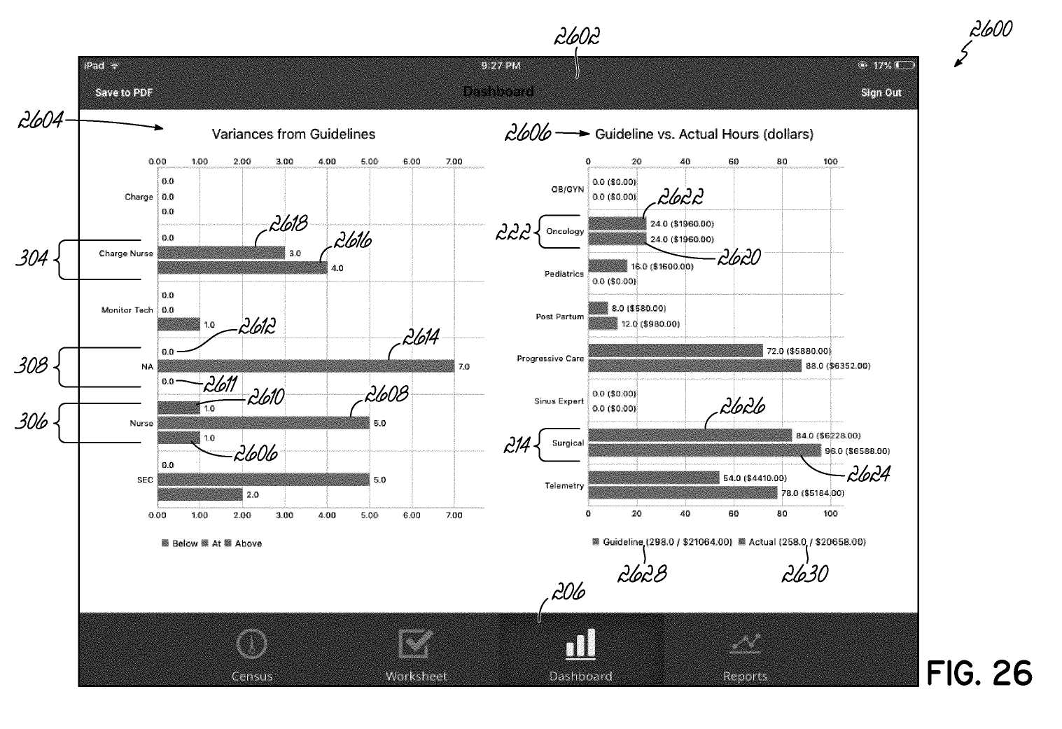

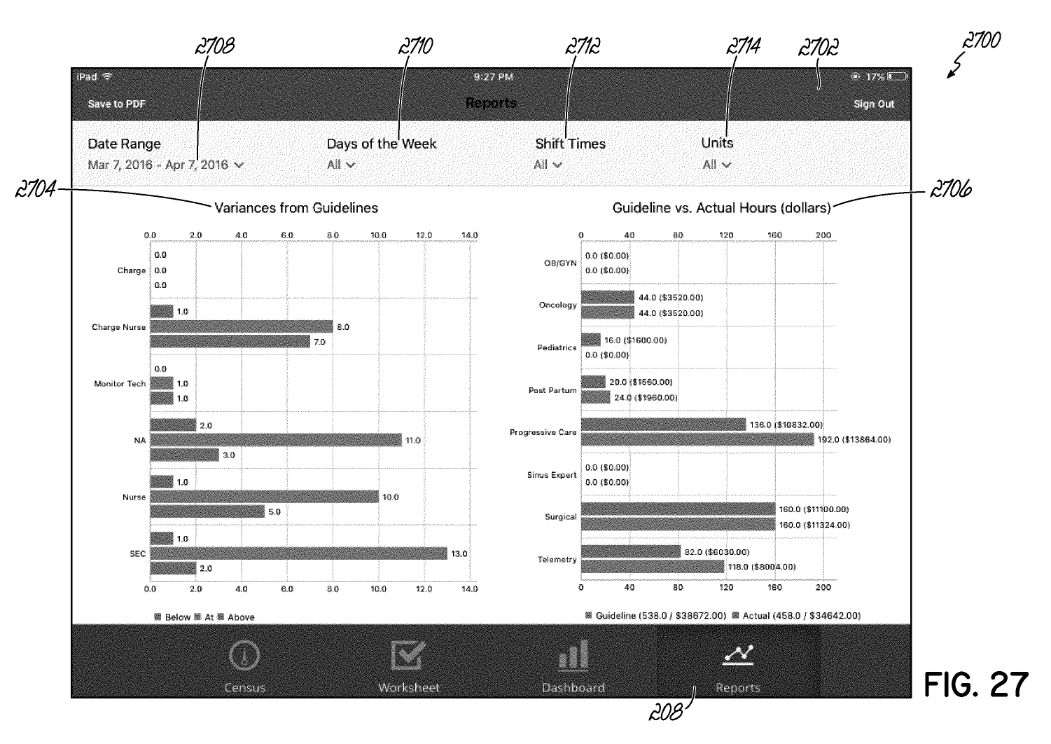

According to further embodiments, the dashboard page and the reports page may be selected by a user selecting buttons 206 and 208, respectively. Buttons 206 and 208 may be implemented in a number of ways, as described above with reference to buttons 202 and 204. The dashboard screen and the reports screen are described below with reference to FIGS. 26 and 27, respectively.

When the census page is selected (e.g., by a user selecting button 202), the GUI 200 may display a user-selectable menu 210 of employment units. The employment units may correspond to teams of employees that perform specific functions within the organization. In this example, the organization is a hospital and includes a telemetry unit 212, a surgical unit 214, a sinus expert unit 216, a progressive care unit 218, a post partum unit 220, an oncology unit 222, and an OB/GYN unit 224, etc. In further embodiments, other employment units may be included as needed. In this example, each user-selectable employment unit has a corresponding button. For example, the telemetry unit 212 may be selected by selecting the telemetry button 226, the surgical unit 214 may be selected by selecting the surgical button 228, etc.

The example illustrated in FIG. 2 shows the GUI 200 in a starting configuration in which no employment unit has been selected. The GUI 200 further includes a display area 230. The display area 230 is used to display information about a selected employment unit. In a state in which no employment unit has been selected, the display area 230 may be blank. In a further embodiment, the display area 230 may display a message 232 that prompts a user to select an employment unit from the menu 210 of user selectable employment units. The system further includes a “sign out” button 234 allowing a user to log out of the system once changes have been implemented, as described in further detail below.

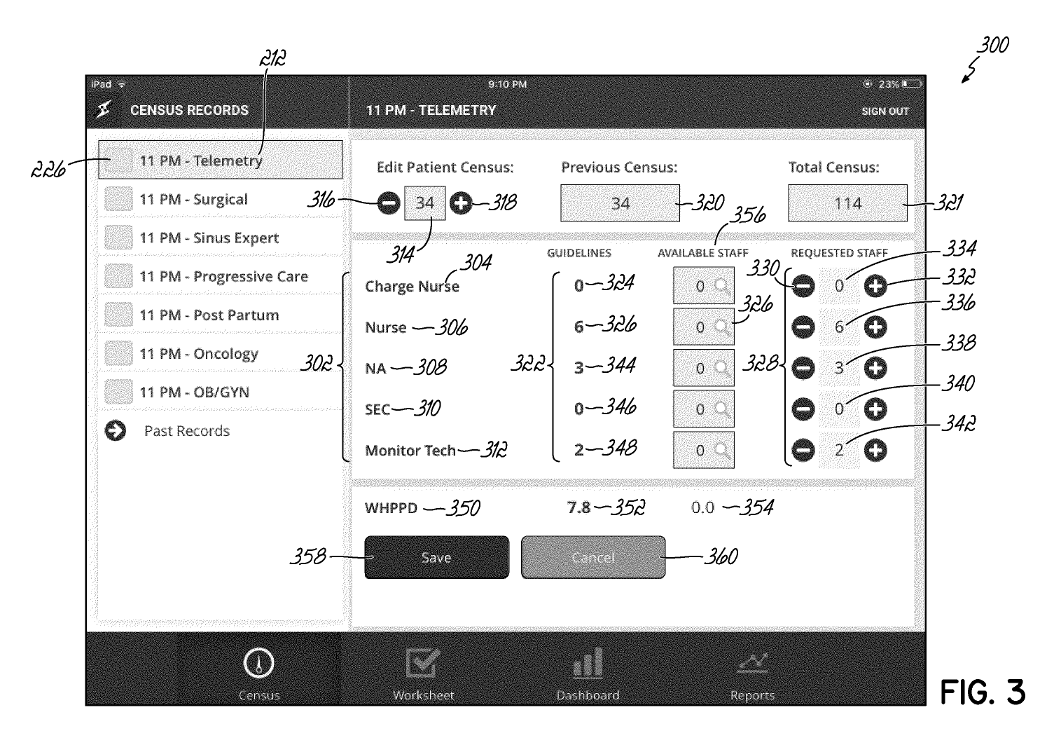

FIG. 3 is a schematic illustration 300 of the GUI 200 of FIG. 2 in a configuration in which the telemetry employment unit has been selected, according to an embodiment. The configuration of FIG. 3 is an example of how the display area 230 of FIG. 2 changes to display information relevant to the telemetry unit upon selection of the telemetry employment unit 212 by selection of the telemetry button 226. In this example, the GUI displays a list 302 of personnel categories. The personnel categories for this example include charge nurse 304, nurse 306, nurse assistant (NA) 308, secretary (SEC) 310, and monitor tech 312. Each category refers to a type of job that may be performed by a member of the hospital staff within the telemetry employment unit 212.

According to an embodiment, each personnel category within an employment unit has a number of attributes. For example, the attributes may include a designation of how many staff personnel are assigned to each staff personnel category for each employment unit. As described in further detail below, the attributes may further include the identity (e.g., names, employee identification numbers, etc.) of each person assigned to a staff personnel category for each employment unit. In general, the number of staff personnel that are needed for a given staff personnel category, for a given employment unit, for a given work shift, depends on the number of patients that require services of the given employment unit. Thus, one piece of information needed for the management of a variable staffing situation for a given work shift is the number of patients requiring services of the employment unit in question. In this example, the patient census 314 denotes the number of patients. In this example, the patient census 314 indicates that there are 34 patients requiring services of the telemetry employment unit 212.

According to an embodiment, the patient census 314 may be edited to increase or decrease the number of patients requiring the services of the employment unit in question (i.e., the telemetry unit 212 in this example). The census page for the selected employment unit may include a minus (“−”) button 316 and a plus (“+”) button 318. A user interacting with the system may increase the patient census 314 by selecting the plus button 318. Similarly, the patient census 314 may be decreased by selecting the minus button 316. In a further embodiment, the patient census 314 may be edited using a pop up keyboard that may be displayed on a touch screen device.

In some situations it may be useful to keep track of how the patient census 314 changes from work shift to work shift. As such, it may be useful to know the previous value of the patient census. In this example, the previous census 320 denotes a previous value of the patient census. In an embodiment, the previous census 320 may refer to the value of the patient census 314 immediately following changes to the patient census 314 resulting from user input (e.g., from a user selecting the minus button 316 or the plus button 318). In a further embodiment, the previous census 320 may refer to the value of the patient census 314 during previous shift, the value of the patient census 314 during a previous day, etc. The system my further provide a total census value 321. According to an embodiment, the value for the total census 321 may denote a total number of patients requiring services of all employment units utilizing the tool.

According to an embodiment, the system may provide guidelines including a suggested number of staff personnel for each personnel category for each employment unit. In this example, guidelines are presented as a list 322 of suggested numbers of staff. For example, the guidelines 322 indicate that the suggested number 324 of charge nurses is 0, the suggested number 326 of nurses is 6, etc. The system provides a list 328 of requested staff for each staff personnel category. In this example, the value of requested staff 328 for each category may be increased or decreased. According to an embodiment, the guidelines are generated directly from a patient census driven matrix embedded into the tool.

Each component of the requested staff 328 variable may have a corresponding minus (“−”) button 330 and a plus (“+”) button 332. Each component of the requested staff 328 variable may be decreased or increased by selection of the corresponding minus button or plus button or utilizing the pop up keyboard that may be displayed on a touch screen display device. In this example, the number of requested staff 328 for the charge nurse 304 may be decreased or increased through selection of the minus button 330 or the plus button 332, respectively. In this example, the number 334 of requested charge nurses is shown as being set to 0 in accordance with the number 324 of charge nurses suggested in the guidelines 328. Similarly, the number 336 of requested nurses is set to 6, in accordance with the number 326 of nurses suggested in the guidelines 322.

In this example, the requested number 338 for NA 308, the requested number 340 for SEC 310, and the requested number 342 for monitor tech 312, is shown as being set equal to the corresponding values (344, 346, and 348) suggested in the list 322 of guidelines. Although the numbers 328 of requested staff are shown as having values equal to respective values in the list 322 of guidelines, there is no reason why the numbers 328 of requested staff may not differ from the numbers 322 suggested in the guidelines.

In some situations, it may be advantageous to have the numbers of requested staff 328 be equal to the respective numbers 322 suggested in the guidelines. This may occur, for example, if the number of patients, as indicated in the patient census 314, is known to be stable over a period of time. For example, it may be known that the number of patients requiring the services of the telemetry unit will have the same value over several work shifts, over several days, over a week, etc. However, if it is known that the number of patients will decrease or increase, it may be advantageous to have the requested number 328 of staff to be less than or greater, respectively, than the number 322 of staff suggested in the guidelines.

For example, if it is known at the beginning of a work shift that a number of patients will be discharged from the hospital during the shift, it may be advantageous to have the requested number 328 of staff selected to be less than the corresponding number 322 suggested by the guidelines. Similarly, if it is known at the beginning of a work shift that the number of patients admitted to the hospital will increase during the shift, it may be advantageous to select the requested number 328 of staff to be greater than corresponding numbers 322 of staff suggested in the guidelines. It may also be the case that the patients present during the particular work shift may need a higher or lower amount of services than is accounted for in the guidelines.

According to an embodiment, it may be advantageous to provide further information that may be of use in generating an employment staffing solution. For example, an average number of worked hours per day 350 (WHPPD) may be indicated. According to an embodiment, the value of WHPPD 350 may be averaged over one or more several shifts. For example, the value 352 of 7.8 indicated for the guidelines 322 may arise in a situation in which individual guideline numbers (e.g., numbers 324, 326, etc.) change over the period of time over which the average is taken.

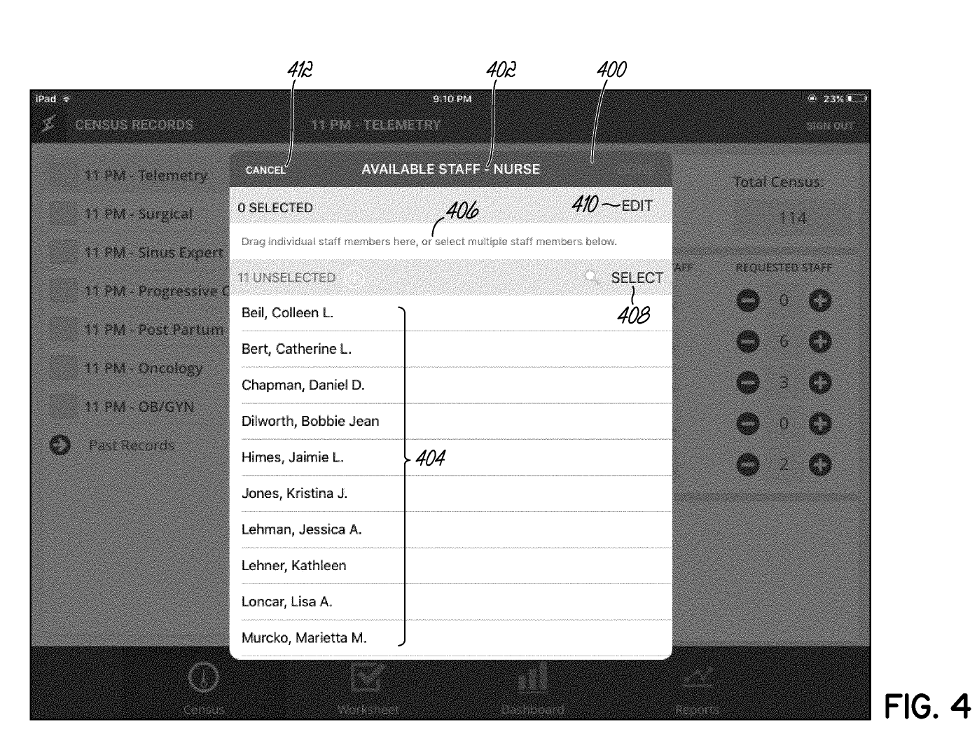

A value 354 of WHPPD 350 is also indicated for available staff 356. As described in greater detail below, the list of values for available staff 356 indicates staff that are assigned to the various staff personnel categories for a given employment unit. FIG. 3 shows the system in a starting configuration before any staff have been assigned, and therefore, each value in the list of values for available staff 356 are set to 0. Further, the corresponding value 354 of WHPPD 350 is also 0. Values for available staff 356 are assigned as described below with reference to FIGS. 4-6. Changes made to the various attributes (e.g., changes to requested staff 328 and/or changes to available staff 356) may then be saved by selecting the save button 358. Alternatively, changes may be rejected by selecting the cancel button 360.

According to an embodiment, values may be assigned to the list 356 of available staff using a drag-and-drop user input utility. The process whereby staff members may be assigned to the nurse 306 category are described in the following example. In this example, the process begins when a user-selectable button 326 from the list 356 of values associated with available staff is selected. In this example, selection of the button 326 for the nurse 306 category, associated with the telemetry 212 employment unit, causes the system to open a drag-and-drop menu of staff personnel that may be selected, as illustrated in FIG. 4 and discussed in further detail below.

FIG. 4 is a schematic illustration of a pop-up window 400 providing a drag-and-drop utility for selecting staff personnel to be assigned as available staff, according to an embodiment. As indicated in the title 402, the drag-and-drop window 400 corresponds to selection of available staff for the nurse 306 category (see FIG. 3). The window is activated by selection of the button 362 for available staff 356 associated with the nurse 306 category (see FIG. 3). FIG. 4 illustrates the window 400 in a state in which no staff members have been selected. The window 400 includes a list 404 of unselected staff members. The list 404 identifies names of user-selectable staff members. In a further embodiment, staff members may be identified in other ways. For example, staff members may be indicated by an employee identification number. In other embodiments, staff members may be indicated by a social security number or any other unique identifier.

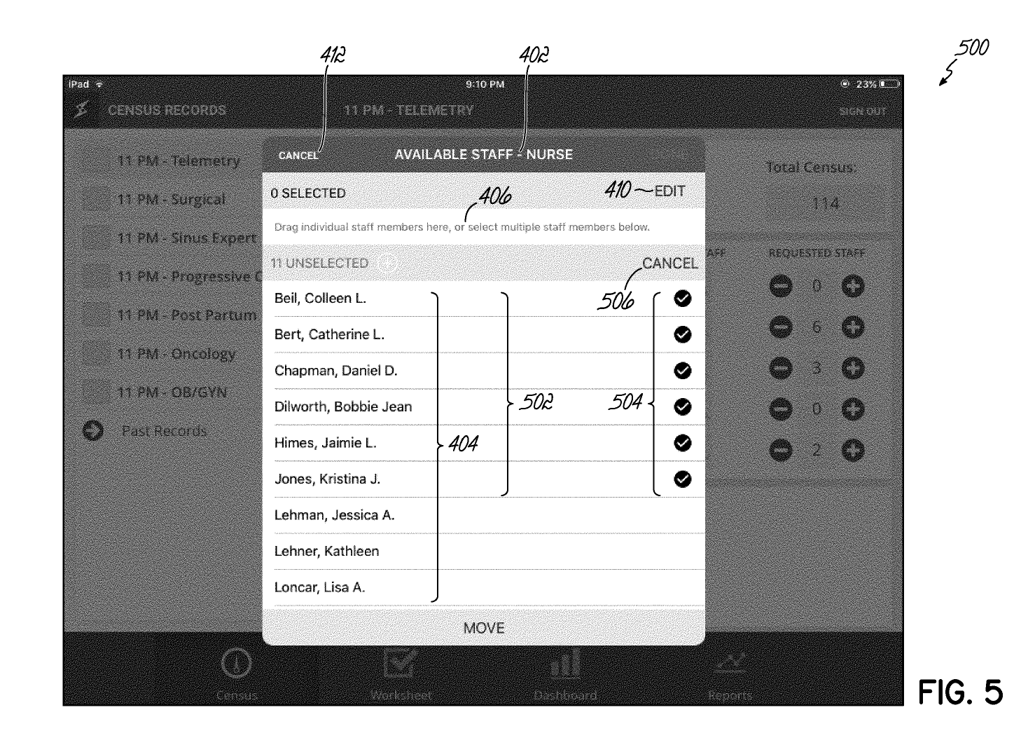

According to an embodiment, window 400 also provides an area 406 where names may be dragged in order to be selected. The process of selection using a drag-and-drop process is well known to persons of ordinary skill in the art. For example, one or names from the list 404 may be selected from a touch screen display by touching the one or more names. In a further embodiment, one or more names may be selected from the list 404 using a mouse or other user input device. The select marking 408 indicates that the system in is a state in which names may be selected from the list 404. The edit marking 410 allows a user to edit selections (once they have been selected) as described below. The cancel marking 412 allows a user to cancel out of the selection window 400 and return to the census page (e.g. see FIG. 3). Once selected, the selected one or more names may be dragged to the destination area 406. The state of the system after 6 names have been selected from the list 404 is illustrated in FIG. 5 and described in further detail below.

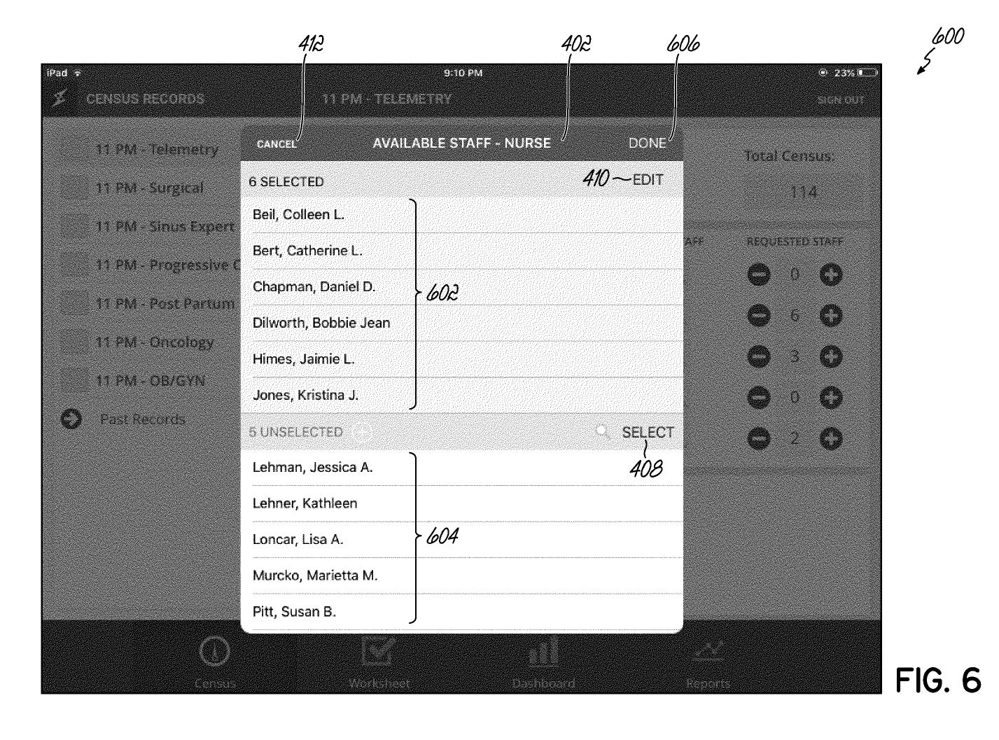

FIG. 5 is a schematic illustration 500 of the pop-up window 400 of FIG. 4 in a state in which staff members have been selected, according to an embodiment. For example, the first 6 names 502 on the list 404 of user-selectable names have been selected, as indicated by the check mark icons 504. The cancel marking 506 allows a user to unselect the selected names 502. The selected names 502 may then be dragged to the destination area 406 as illustrated in FIG. 6 and described in further detail below.

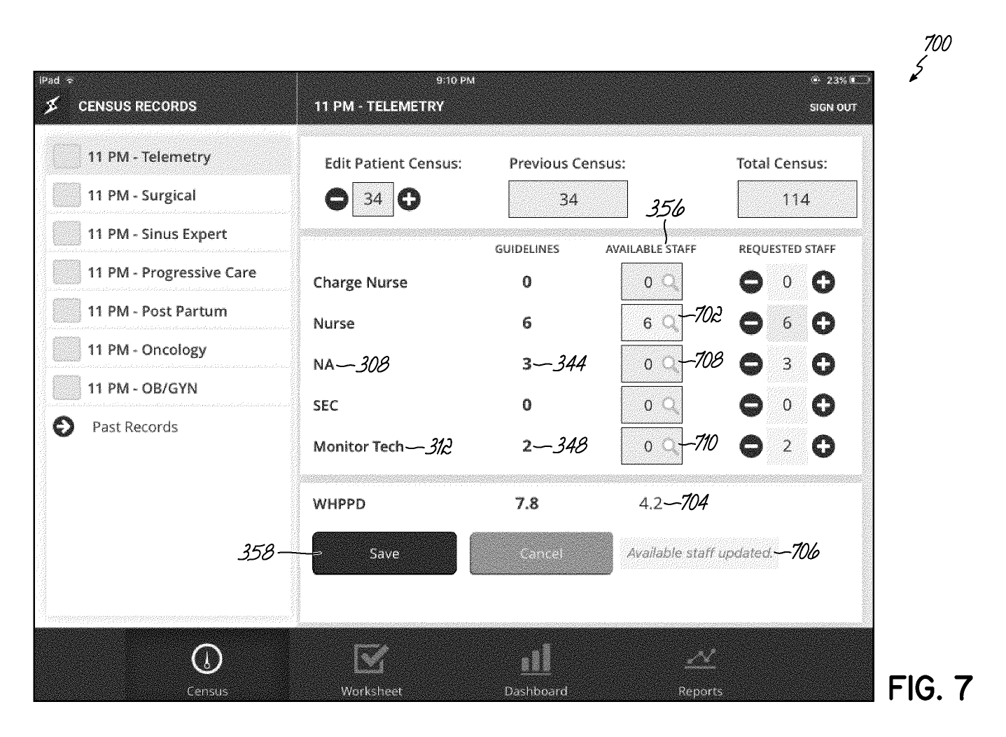

FIG. 6 is a schematic illustration 600 of the pop-up window 400 of FIG. 5 in a state in which staff members that have been selected 502 have been dragged to the destination area 406, according to an embodiment. In this example, the destination area 406 changes to include a list 602 of selected names. Upon dragging the list 502 (see FIG. 5) of selected names to the destination area 406 (see FIG. 5), list of unselected names 404 is updated to include an updated list 604 of unselected names that excludes the names found in the list 602 of selected names. The select marking 408 indicates that more names may be selected from the updated list 604 of unselected names. Further, the edit marking 410 provides a utility whereby names in the list 602 of selected names may be edited, deselected, or deleted, as briefly described above. The done marking indicates a button 606 that may be selected when a user has finished making selections using the drag-and-drop window 400. Once the done button 606 has been selected, the pop-up window 400 vanishes and the GUI returns to displaying the census screen as illustrated in FIG. 7 and described in further detail below.

FIG. 7 is a schematic illustration 700 of the updated census screen as it appears after staff members have been selected using the drag-and-drop pop-up selection window of FIGS. 4-6, according to an embodiment. Following the operations described above and illustrated in FIGS. 4-6, the value of available staff 356 (see FIG. 3) has been updated from the previous value 362 of 0 to the updated value 702 of 6. Similarly, the previous value 354 of 0 for WHPPD 350 associated with available staff 356 has been updated to the updated value 704 of 4.2. In this example, a message 706 is also provided indicating that numbers associated with available staff have been updated but have not yet been saved. The changes may then be saved by selection of the save button 358.

According to an embodiment, a similar procedure to that described with reference to FIGS. 4-6 may then be employed to update numbers of available staff associated with other employment categories. For example, the number of staff associated with NA 308 may be updated by selecting a button 708 associated with NA. Upon selection of button 708, a selection window similar to pop-up window 400 (see FIGS. 4-6) is then be invoked that provided a user the opportunity so select staff personnel to be associated with NA 308. For example, it may be advantageous to set the number of available staff associated with NA to equal the value 344 suggested by the list 322 of guideline numbers. In this example, the suggested number 344 is equal to 3.

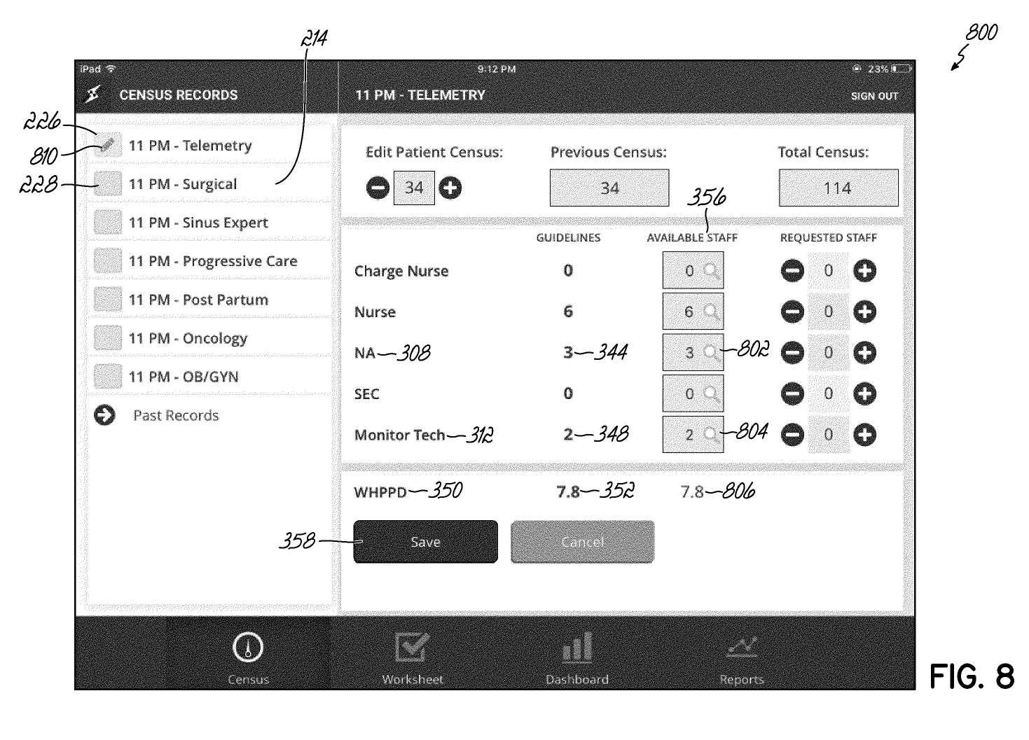

A similar drag-and-drop approach may be used to set the numbers of available staff associated with other employment categories. In this example, the remaining non-zero value suggested by the list 322 of guideline numbers is the number 348 associated with monitor tech 312 (see FIG. 3). In this example, the number 348 associated with monitor tech 312 suggested in the list 322 of guideline numbers has a value of 2. A process to update value of available staff associated with the monitor tech 312 category may be initiated by selecting button 710. The result of performing the drag-and-drop procedure to update values 344 and 348 (see FIG. 3) is illustrated in FIG. 8 and described in further detail below.

FIG. 8 is a schematic illustration 800 of the updated census screen as it appears after staff members for three employment categories have been selected and saved using the drag-and-drop pop-up selection window of FIGS. 4-6, according to an embodiment. The number 802 of available staff corresponding to the category NA 308 now has the value 3 which equals the value 344 of the suggested guideline number for NA 308.

Similarly, the number 804 of available staff corresponding to category monitor tech 312 now has the value 2 which equals the value 348 of the suggested guideline number for monitor tech 312. Further, the number 806 for WHPPD 350 corresponding to available staff now has been updated to take the value 7.8 which equals the value 352 for WHPPD corresponding to the suggested guideline numbers. According to an embodiment, FIG. 8 illustrates the way the census screen may look after all selections have been made for available staff 356 but prior to saving by selecting the save button 358. In this example, the appearance of the telemetry button 226 has changed to now show a visual indicator 810 to alert a user that selections have been made but have not yet been saved. In this example, the visual indicator 810 is icon depicting an illustration of a pencil. In other embodiments, the system may be configured to utilize different visual indicators to show that changes have been made and saved.

Selections for other employment units may be made using a process similar to that described above. For example, a user may select the surgical button 228 in order to display information for the surgical employment unit 214. Selections for requested and available staff can then be made for the surgical unit 214 using a procedure similar to that described above with reference to the telemetry unit 212. Staffing selections may also be made using the worksheet screen as illustrated in FIGS. 9-19, and described in further detail below.

FIG. 9 is a schematic illustration 900 of a first configuration of the worksheet page, according to an embodiment. As mentioned above, the worksheet page may be invoked by selecting the worksheet button 204 displayed in the GUI (see FIG. 2). Upon selection of the worksheet button 204, the content displayed on the GUI changes to show a partial view of the worksheet page as shown, for example, in FIG. 9. According to an embodiment, the worksheet includes information similar to that provided on the census page presented in a scrollable screen format. In this example, a user may view information for a first employment unit in one configuration of the scrollable screen and then may change the configuration of the scrollable screen to view information for a second employment unit, a third employment unit, etc. In the example shown in FIG. 9, the worksheet page is in a first configuration that shows information for the surgical unit 214. FIG. 9 also shows a partial view of information for the OB/GYN unit 224.

According to an embodiment, information displayed in FIG. 9 for the surgical unit 214 includes guideline numbers 902, available staff 904, and requested staff 906, for the list 908 of staff personnel categories. In this example, the list 908 of staff personnel categories differs from the list 302 of staff personnel categories 302 associated with the telemetry unit 212 (see FIG. 3) due to the exclusion of the monitor tech 312 category. In general, a first employment unit may have more staff personnel categories that that of a second employment unit. Alternatively, a first employment unit may have fewer staff personnel categories than a second employment unit. In some embodiments, the list of personnel categories for a first and second employment unit may coincide.

According to an embodiment, information displayed in FIG. 9 for the surgical unit 214 further includes a calculated worksheet variance 910 for each employment category in the list 908 of employment categories. In this example, the worksheet variance 910 is calculated as a difference between a value associated with available staff 904 and a corresponding value associated with requested staff 906. For example, for the nurse 306 category the number 912 associated with available staff 904 has a value equal to 2, while the corresponding number 914 associated with requested staff 906 as a value equal to 3. Therefore, for this example, the number 916 associated with the variance 910 is the difference between the values of numbers 912 and 914, that is, the variance 916 equals −1 (i.e., 2−3=−1). In a further example, the number 918 associated with available staff 904 and the number 920 associated with requested staff 906 are subtracted to determine the variance 922 associated with the NA category 308. In this example, the variance 922 equals +2 (i.e., 2−0=+2).

In this example, the list 910 of variances corresponding to the list 908 of employment categories provides a metric that is useful for the management of variable staffing and productivity. A negative value of a variance 910 indicates that the value of requested staff 906 is greater than the value of available staff 904. In this example, the nurse 306 category has a negative value 916 of variance equal to −1. Alternatively, a positive value of the variance 910 indicates that the available staff 904 is greater than the corresponding value of the requested staff 906. In this example, the NA 308 category has a positive value equal to +2. It is necessary to select numbers of available staff 904 to be equal to corresponding numbers of requested staff 906 to reduce the absolute value of the variance 910. In this way the supply (i.e., available staff) will equal the demand (i.e., requested staff).

According to an embodiment, the worksheet screen also provides a drag-and-drop utility for changing the values of available staff 904. For example, the worksheet screen of FIG. 9 provides a “call in extra” drag-and-drop utility 924 that allows a user to increase the number of available staff 904 for a given category of staff personnel selected from the list 908 of staff personnel, as described in further detail below. Similarly, a “flex off” drag-and-drop utility 926 is provided in order to reduce the number of available staff 904 for a given category of staff personnel selected from the list 908 of staff personnel, as described in further detail below. The worksheet page further includes a save button 928 to save changes and a reset button 930 to reject changes. Once changes have been set and saved for a given employment unit, the configuration of the worksheet page may be changed by scrolling the page to view information for another employment unit, as described in further detail below.

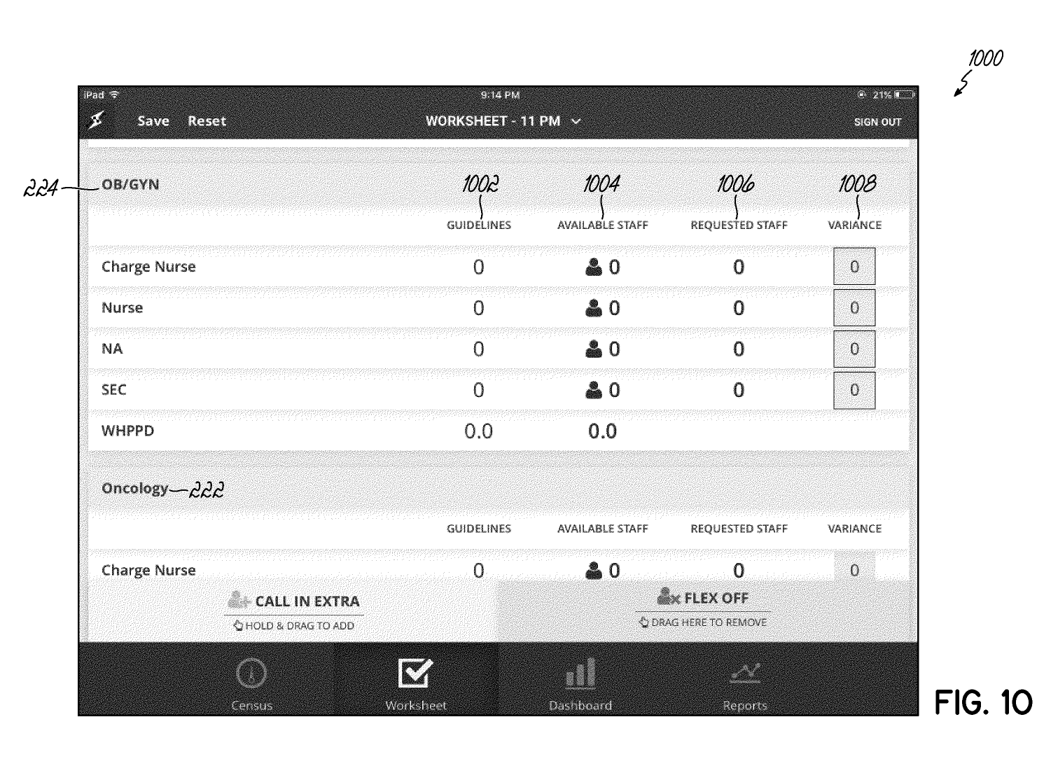

FIG. 10 is a schematic illustration 1000 of a second configuration of the worksheet page, according to an embodiment. In this example, the configuration of the worksheet page has been changed by scrolling down or up on the screen to view information for the OB/GYN 224 employment unit. In this configuration, complete information is shown for the OB/GYN 224 employment unit while partial information is shown for the oncology 222 unit. In this example, the settings for the OB/GYN 224 unit are in an initial state in which no selections have been made and consequently all values for guidelines 1002, available staff 1004, requested staff 1006, and variance 1008 are all equal to 0.

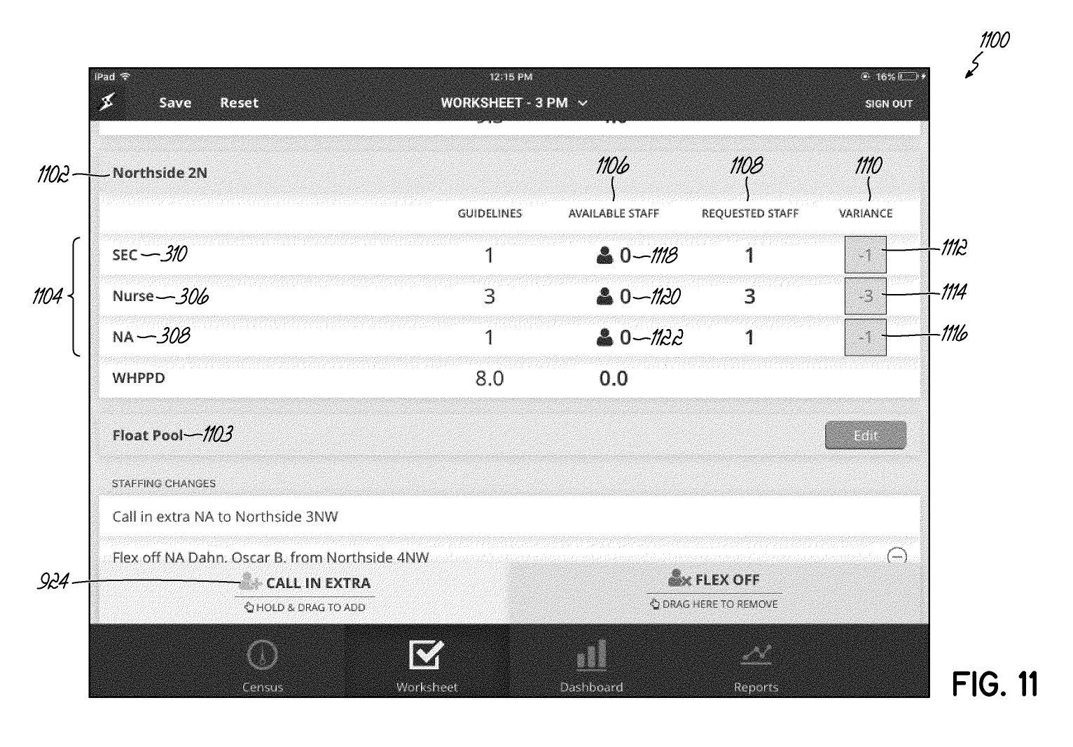

FIG. 11 is a schematic illustration 1100 of a third configuration of the worksheet page, according to an embodiment. In this example, the configuration of the worksheet page has been changed by scrolling to view the northside 2N 1102 employment category, which was not previously discussed. In this configuration of the worksheet page, a partial view is also shown providing information for the float pool 1103, which is described in greater detail below. In a further embodiment, the worksheet may have additional configurations. For example, the worksheet may include separate screens, one for each staffing unit. For example, all nurses by unit may be displayed of a first screen, all NAs by unit may be displayed on a second screen, all SECs by unit may be displayed by unit on a third screen, etc.

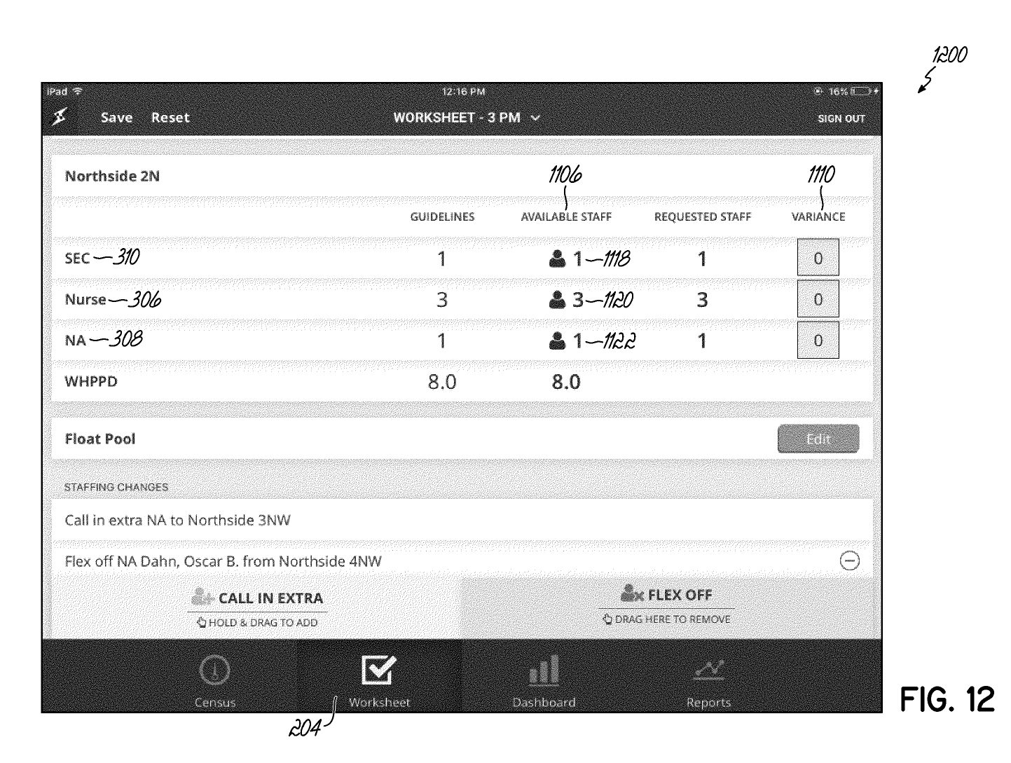

In the example of FIG. 11, the list 1104 of staff personnel categories is different from the list 302 associated with the telemetry 212 category of FIG. 3, and the list 1104 is different from the list 908 of staff personnel categories associated with the surgical unit 214. In this example, all numbers of available staff equal 0. Consequently, because the numbers 1108 of requested staff are non-zero, there are negative values of the variance 1110 for each of the staff personnel categories in the list 1104. For example, for the SEC 310 category there is a variance value 1112 equal to −1. Similarly, for the nurse 306 category there is a variance value 1114 equal to −3. Lastly, for the NA 308 category there is a variance value 1116 equal to −1. The drag-and-drop utility can be used to increase individual numbers of available staff 1106 for respective staff personnel categories 1104. The result for such a drag-and-drop process is illustrated in FIG. 12, and described in greater detail below.

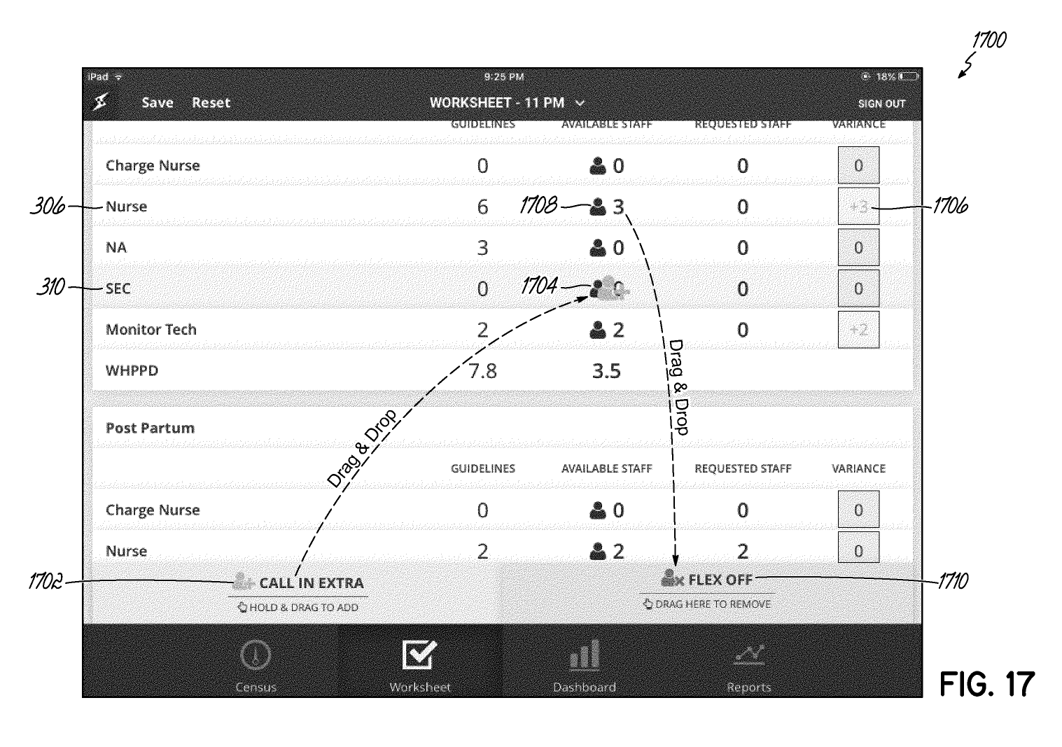

FIG. 12 is a schematic illustration 1200 showing the result of the use of a drag-and-drop utility 924 to increase the number of available staff starting with the configuration of the worksheet page of FIG. 11, according to an embodiment. This drag-and-drop utility is discussed in greater detail below with reference to FIG. 17. In this example, the number 1118 of available staff 1106 corresponding to the SEC 310 category has been changed from the value of 0 in FIG. 11 to the value equal to 1 in FIG. 12. Similarly, the number 1120 of available staff 1106 corresponding to the nurse 306 category has been changed from the value of 0 in FIG. 11 to the value equal to 3 in FIG. 12. Similarly, the number 1122 of available staff 1106 corresponding to the NA 308 category has been changed from the value of 0 in FIG. 11 to the value equal to 1 in FIG. 12. These changes result in each of the values of variance 1110 taking on values equal to 0.

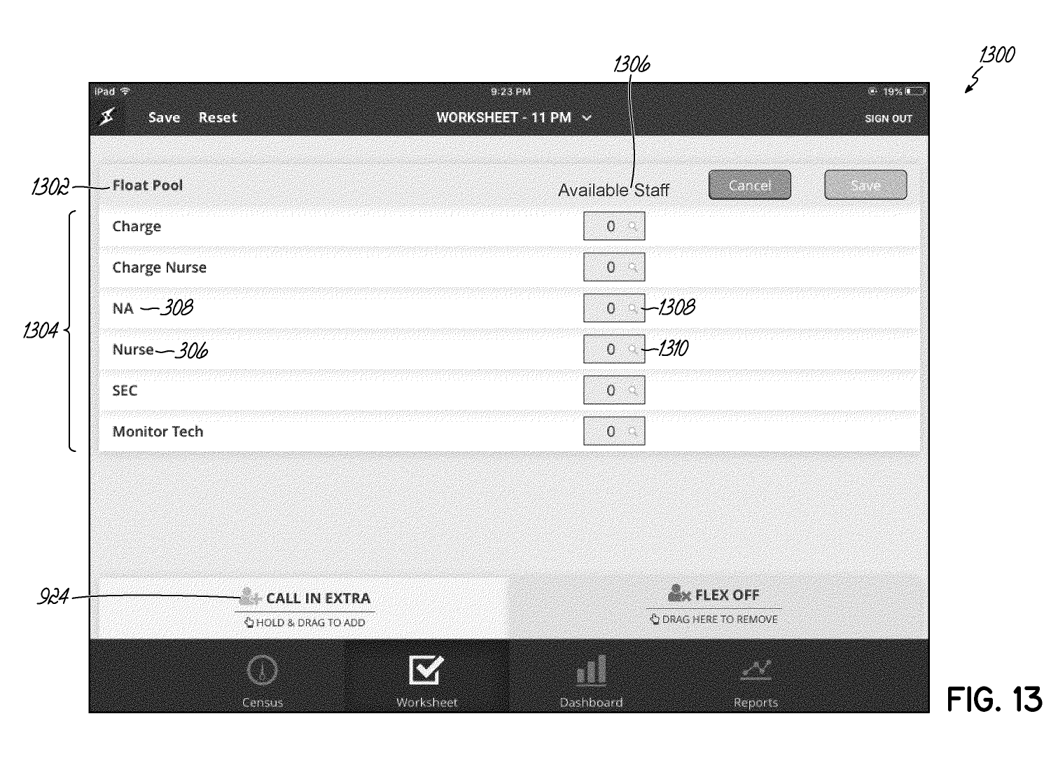

FIG. 13 is a schematic illustration 1300 of a fourth configuration of the worksheet page, according to an embodiment. The configuration shown in FIG. 13 was obtained by scrolling to show information related to the float pool 1302 employment category. The float pool 1302 is a general employment unit that provides a collection of staff personnel that may be needed in other employment units throughout a work shift depending on fluctuating needs of the other employment units.

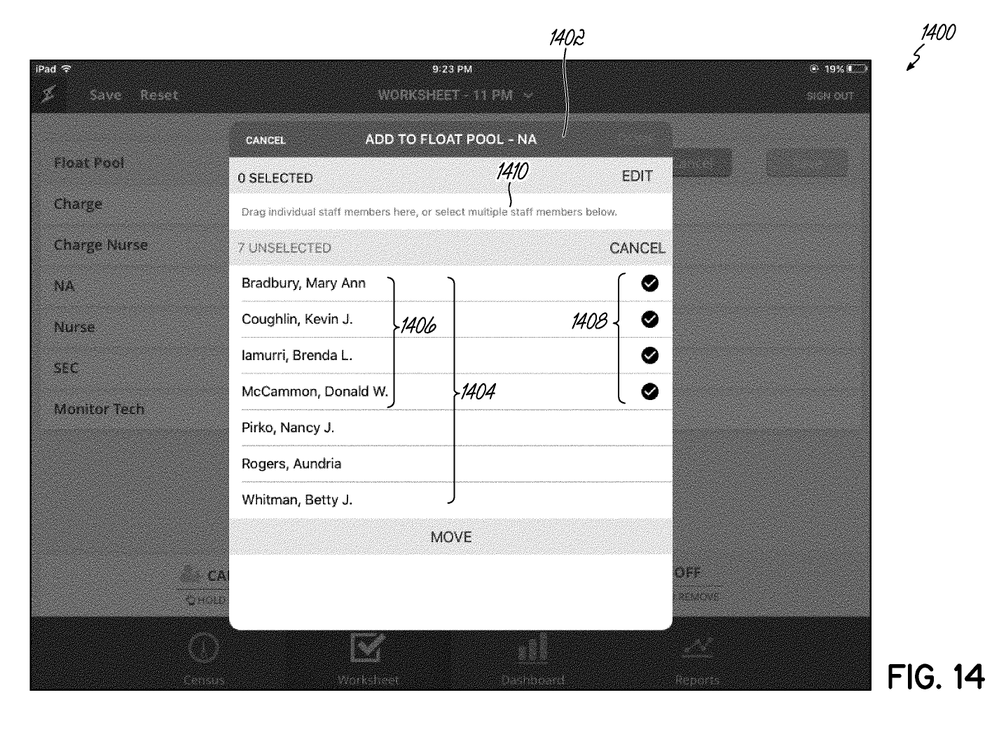

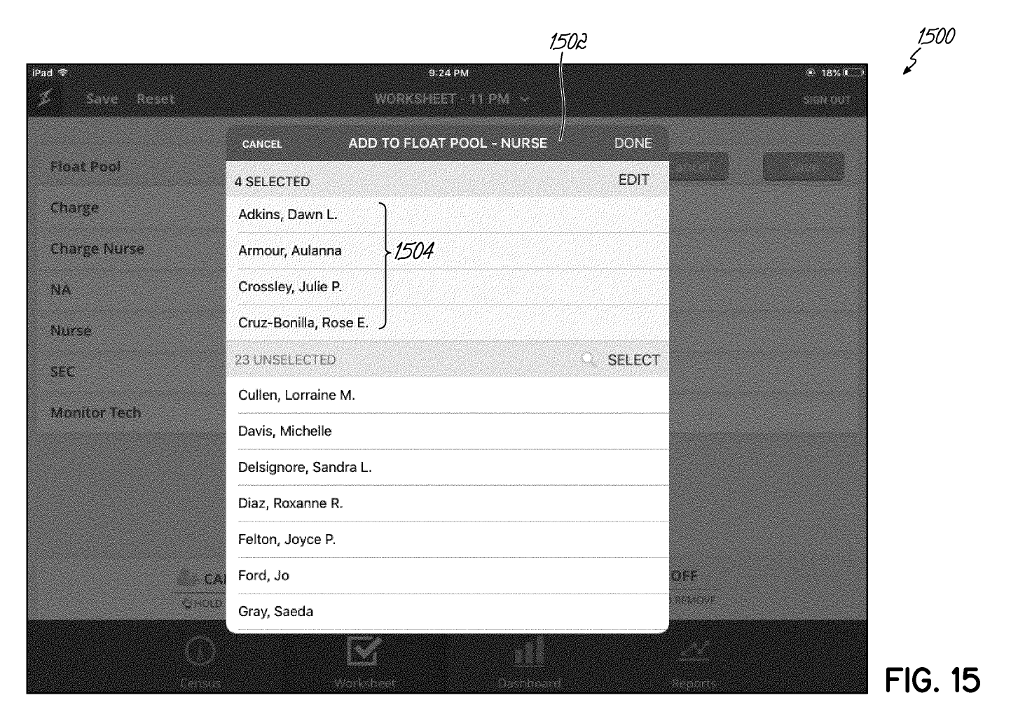

The float pool 1302 includes a list 1304 of staff personnel categories that is different from the list 302 of personnel categories associated with the telemetry unit 212 (see FIG. 3), is different from the list 908 of personnel categories associated with the surgical unit 214 (see FIG. 9), and is different from the list 1104 of personnel categories associated with the northside 2N 1102 unit. The float pool is populated with staff assigned to that unit. The float pool has no census or staffing guidelines. It is only a staff resource pool. Staff are reassigned from the float pool to other units on the worksheet using the “drag and drop” utility 924, as illustrated in FIGS. 14-16 and described in further detail below. For example, to make changes to the available staff 1306 associated with the NA 308 category, a user may select button 1308 which opens a pop-up window as shown in FIG. 14, and described in further detail below. Similarly, to make changes to the available staff 1306 associated with the nurse 306 category, a user may select button 1310 which opens a pop-up window as shown in FIG. 15, and described in further detail below.

FIG. 14 is a schematic illustration 1400 of a drag-and-drop pop-up window 1402 used to select available staff personnel for the NA category 308 of the float pool 1302, according to an embodiment. The pop-up window 1402 may be invoked by selection of button 1308 of FIG. 13. The selection of personnel for the NA category 308 of the float pool 1302 follows a procedure similar to that described above with reference to FIGS. 4-6 for the example of selecting available staff for the nurse 306 category associated with the telemetry 212 unit (see FIGS. 3-7 and related discussion).

In this example, pop-up window 1402 includes a list 1404 of user-selectable staff personnel. In this example, a list 1406 of 4 staff members has been selected, as indicated by the check mark icons 1408. As was shown in FIGS. 5 and 6, the list 1406 of selected personnel may then be dragged to destination area 1410. This process results in the selected personnel 1406 being added to the available personnel 1306 for the NA 308 category (see FIG. 13). A similar procedure may be followed to select personnel for the nurse 306 category of FIG. 13, as shown in FIG. 15 and described in further detail below.

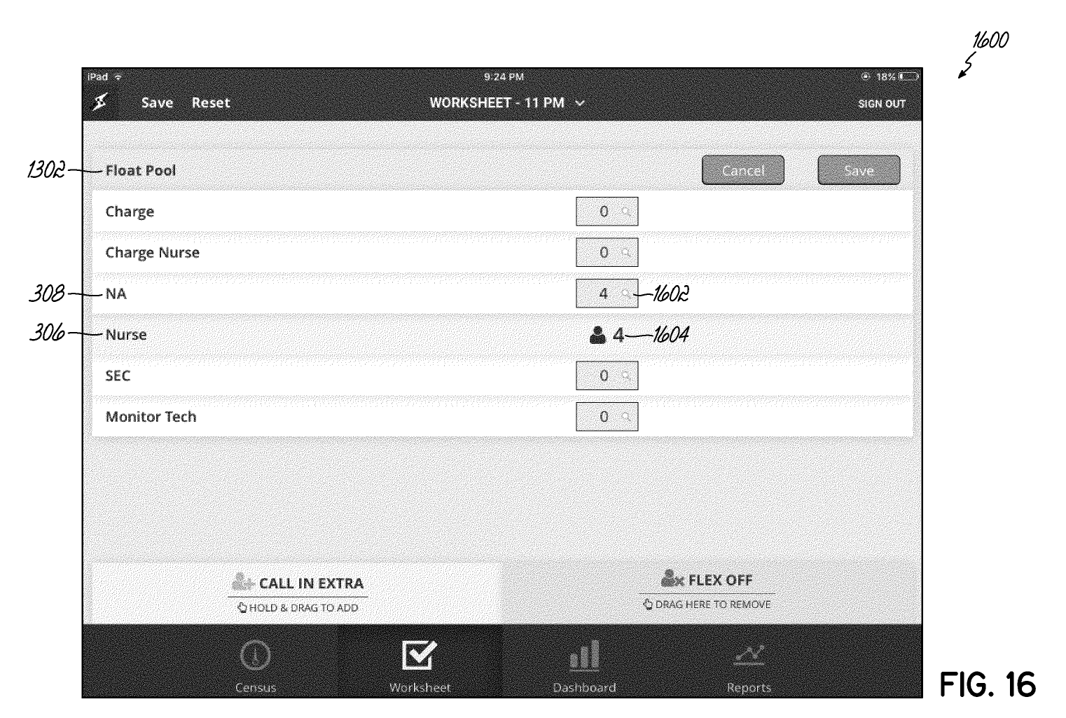

FIG. 15 is a schematic illustration 1500 of a drag-and-drop pop-up window 1502 used to select available staff personnel for the nurse 306 category of the float pool 1302 unit, according to an embodiment. FIG. 15 is similar to FIG. 6 showing a list 1504 that has been selected and dragged to a destination area (similar to destination area 1410 of FIG. 14). Upon closing the pop-up window 1502, control is returned to the worksheet page which is updated to show changes to available personnel of the float pool 1302 as shown in FIG. 16.

FIG. 16 is a schematic illustration 1600 showing changes to the float pool due to the drag-and-drop processes of FIGS. 14 and 15, according to an embodiment. For example, the process illustrated in and discussed with reference to FIG. 14 was used to increase the number 1602 of available personnel associated with the NA 308 category, while the process illustrated in and discussed with reference to FIG. 15 was used to increase the number 1604 of personnel associated with the nurse 306 category.

FIG. 17 is a schematic illustration 1700 showing further details for the drag-and-drop “call in extra” and “flex off” utilities, according to an embodiment. In this example, a user may use a mouse or other user-input device to select the “call in extra” icon 1702. Once selected, the “call in extra” icon 1702 may be dragged-and-dropped to a corresponding icon 1704. In this example, the process of dragging icon 1702 and dropping to icon 1704 performs the operation of increasing the number of available staff personnel for the SEC 310 category.

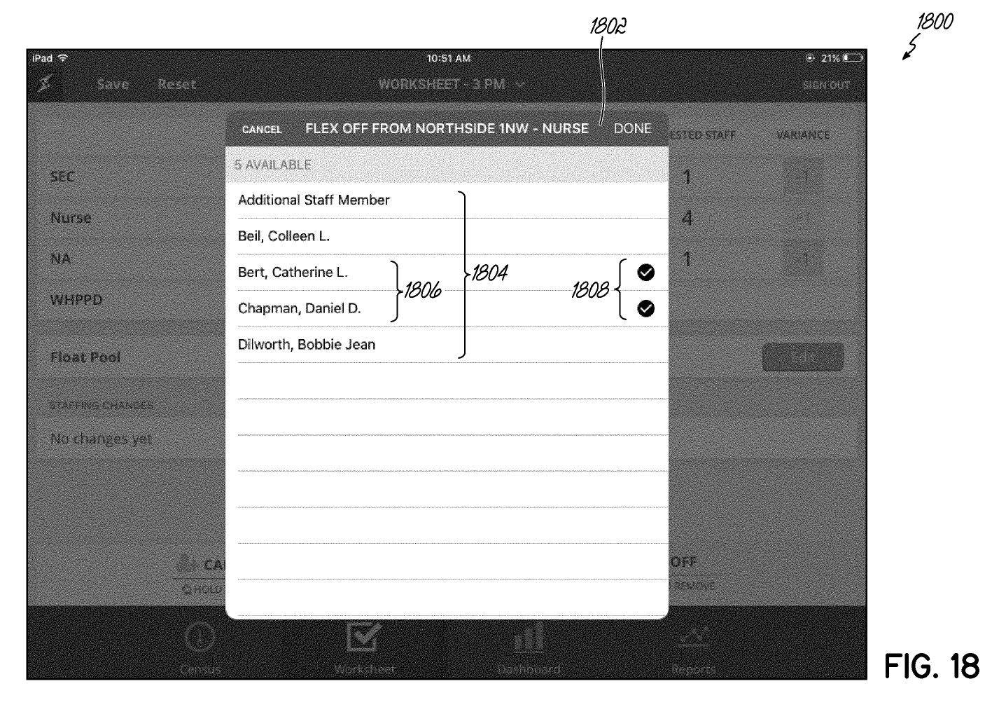

A similar drag-and-drop procedure may be invoked to remove available staff for a category having a positive variance. In this example, the nurse 306 has a surplus of 3 staff persons as indicated by the variance 1706 that has a value equal to +3. The icon 1708 may be selected by a mouse or similar user input device. Once selected, the icon 1708 may be dragged and dropped on the “flex off” icon 1710. In this example, the process of dragging icon 1708 and dropping to icon 1710 performs the operation of removing one available staff personnel member from the nurse 306 category. In a further embodiment, the “flex off” process of removing available personnel may be performed using a pop-up drag-and-drop window, as illustrated in FIG. 18 and described in further detail below.

FIG. 18 is a schematic illustration 1800 showing the use of a drag-and-drop pop-up window 1802 used to remove available staff personnel using the “flex off” utility, according to an embodiment. In this example, dragging icon 1708 to the “flex off” icon 1710 invokes the pop-up window 1802 that includes a list 1804 of assigned personnel that may be removed. In this example, a list 1806 of 2 staff members has been selected as indicated by the check mark icons 1808. Staff that are removed using the “flex off” utility may be sent home on a rotating basis as needed.

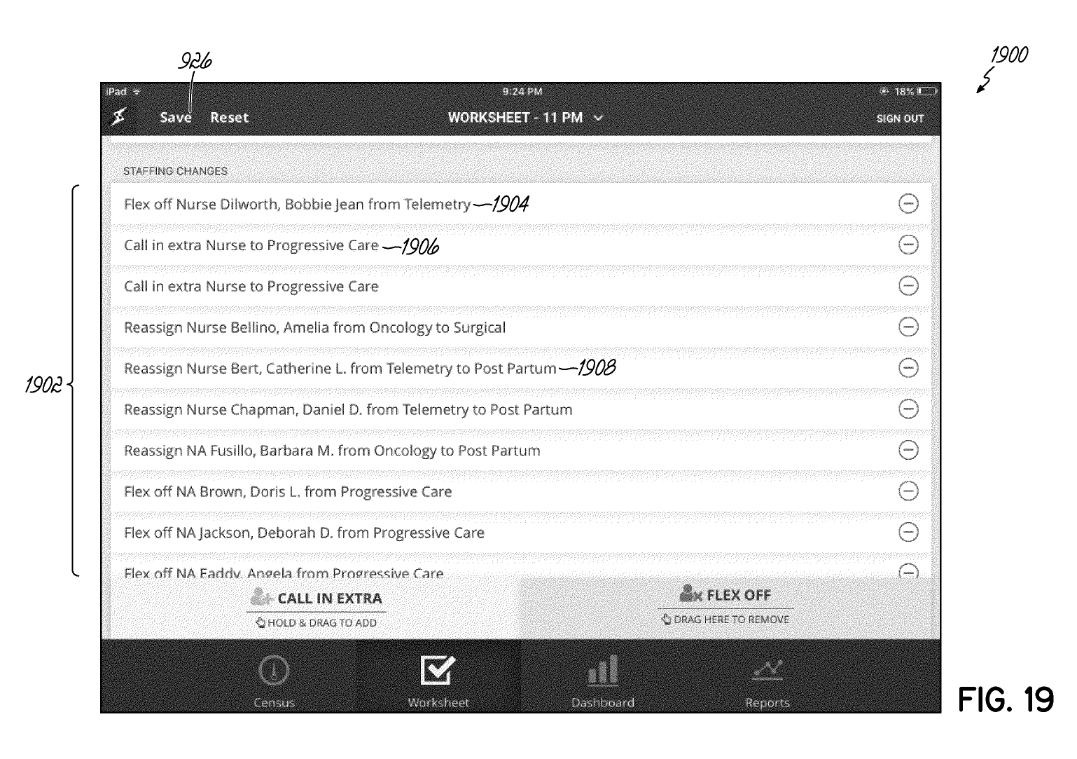

FIG. 19 is a schematic illustration 1900 of a fifth configuration of the worksheet page showing a list 1902 of changes, according to an embodiment. This configuration was obtained by scrolling to change the display of the worksheet page to show the list 1902 of changes. The list 1902 of changes summarizes all changes that were made to the worksheet as discussed above with reference to FIGS. 9-18. For example, the list 1902 shows a message 1904 indicating that a nurse was removed from the telemetry 212 unit using the “flex off” utility. As a further example, list 1902 includes a message 1906 showing that a nurse called in to the progressive care 218 using the “call in extra” utility. Staff personnel that are assigned using the “call in extra” utility may be available in an “on call” status or may be notified by phone, e-mail, text message, etc. that they are needed for a particular shift. Staff personnel may also be called in from an outside staffing agency.

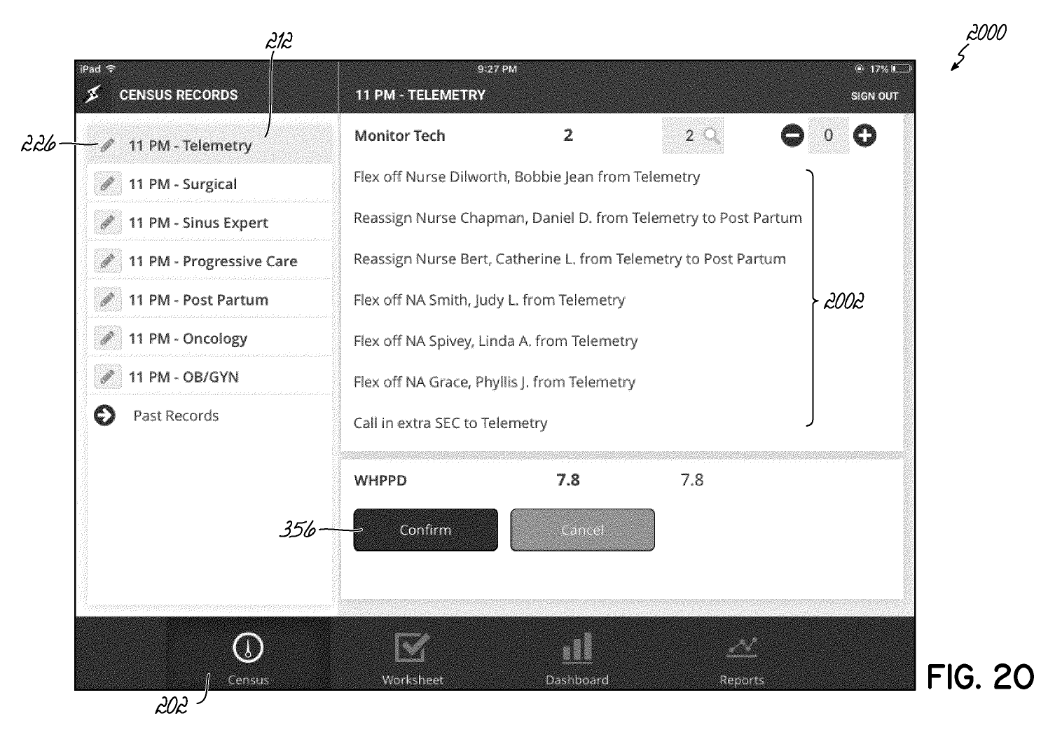

In addition to information regarding personnel being added to or removed from a given employment unit, list 1902 further includes messages indicating staff members that have been reassigned from one unit to another. For example, list 1902 includes a message 1908 indicating that a nurse was reassigned from the telemetry 212 unit to the post partum 220 unit see FIG. 2). As described above, staff members may be reassigned on the worksheet screen using the “drag and drop” utility. Once a user is satisfied with the changes shown in list 1902, all changes may be saved by selecting the save button 928. According to an embodiment, once changes have been saved on the worksheet screen they must also be confirmed on the census page as illustrated in FIGS. 20-25 and described in greater detail below.

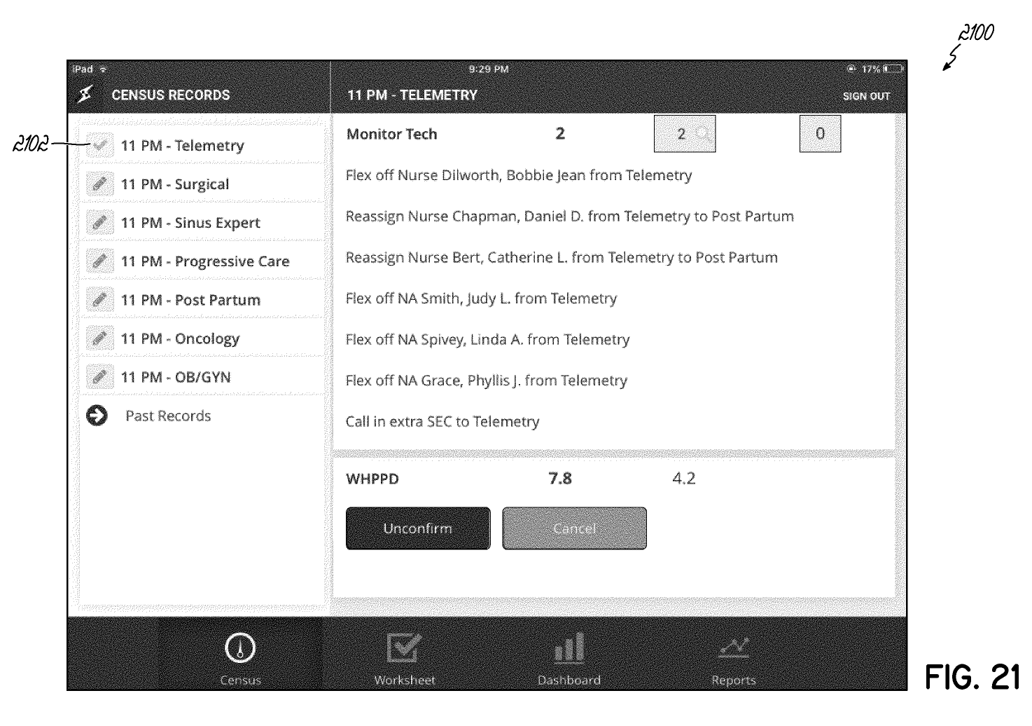

FIG. 20 is a schematic illustration 2000 of the census page showing a list 2002 changes awaiting confirmation for the telemetry unit, according to an embodiment. After making and saving changes to the worksheet page, as described above, a user may return to the census page by selecting the census button 202. The list 2002 of changes for the telemetry 212 unit is displayed upon selection of the telemetry button 226. The changes may be confirmed by selecting the confirm button 356. Once changes have been confirmed, a visual indicator is provided as shown in FIG. 21 and described in further detail below.

FIG. 21 is a schematic illustration 2100 of the census page showing a visual indicator 2102 that changes for the telemetry unit have been successfully confirmed, according to an embodiment. In this example, the visual indicator is a checkmark icon 2102. In this example, an assumption was made that the changes to be confirmed resulted in all variances having values equal to 0. In other situations it may be advantageous to have non-zero variances, as mentioned above and described in further detail below.

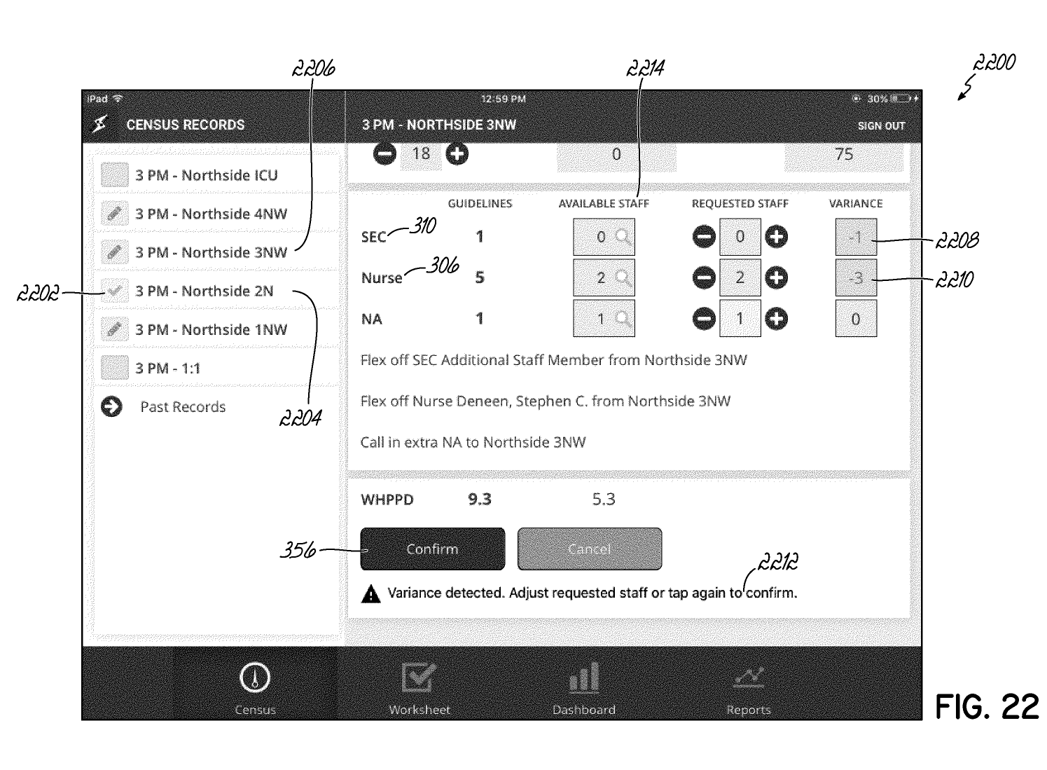

For example, if demands of a given employment unit are expected to increase during a given shift, it may be desirable to have a positive value for a given variance indicating extra staff that are anticipated to be needed. Similarly, if demands of a given employment unit are expected to decrease over a shift, it may be desirable to have a negative variance indicating a decreased staff. In most circumstances, however, it is desirable to have variances having values equal to zero. Therefore, according to an embodiment, a warning may be given when a user attempts to confirm changes having non-zero variances. This latter situation is illustrated with respect to FIGS. 22-25 and described in further detail below.

FIG. 22 is a schematic illustration 2200 of the census page showing a situation in which a warning is given that certain variances are non-zero, according to an embodiment. In this example, visual indicator 2202 indicates that changes for the northside 2N unit 2204 have been successfully saved and confirmed. Currently the northside 3NW 2206 unit has been selected and a user is attempting to confirm the changes by selecting the confirm button 356. In this situation, however, some of the variances are non-zero.

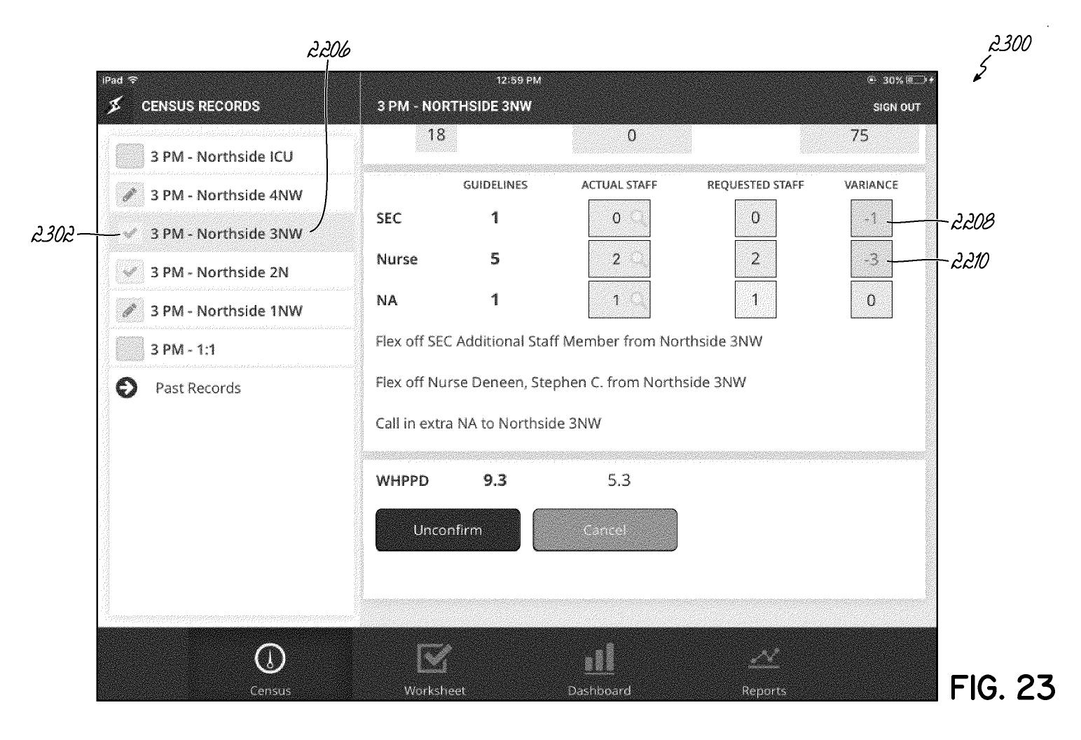

In this example, the SEC 310 category has a census variance value 2208 equal to −1. The census variance, introduced here, is defined as a difference between available staff and guideline staff. This census variance is in contrast to the worksheet variance (introduced above) that is defined to be a difference between a number of available and requested staff. In this example, the nurse 306 category has a census variance value 2210 equal to −3. In this situation, therefore, the system provides a warning message 2212 indicating that some of the variances have non-zero values. The user then has the opportunity to change values of available staff 2214 to yield variances equal to zero. Alternatively, the user may confirm that they wish to keep the non-zero variances by once again selecting the confirm button 356. The result of performing this action of re-selecting the confirm button 356 in response to the message 2212 is shown in FIG. 23 and discussed in further detail below.

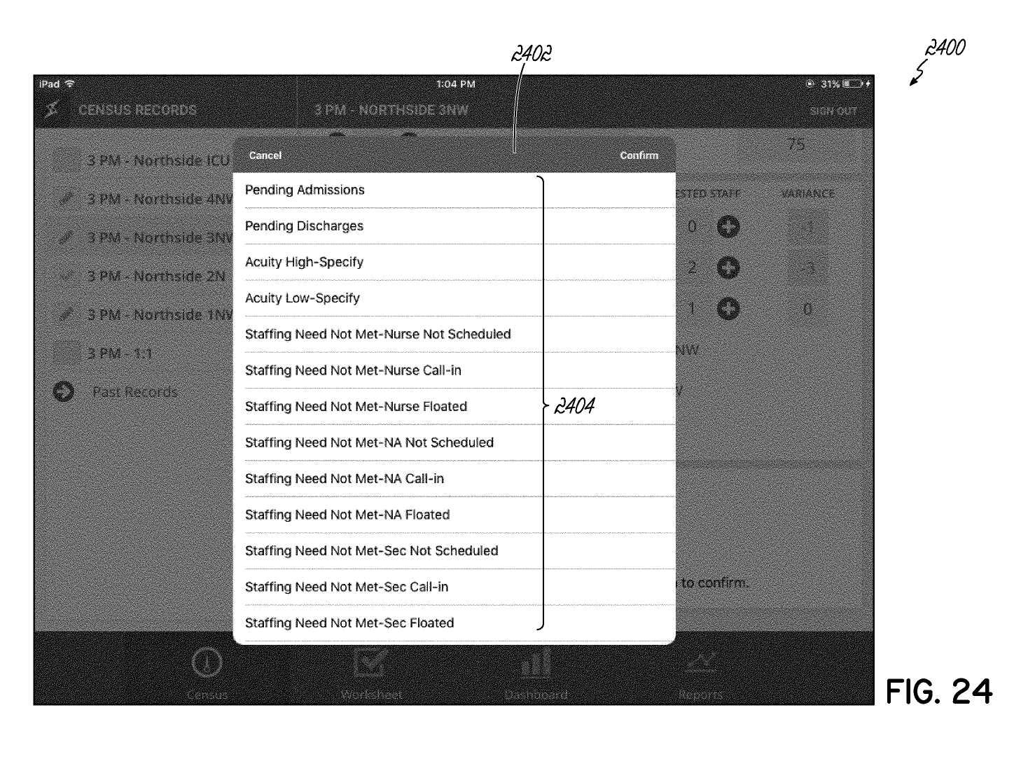

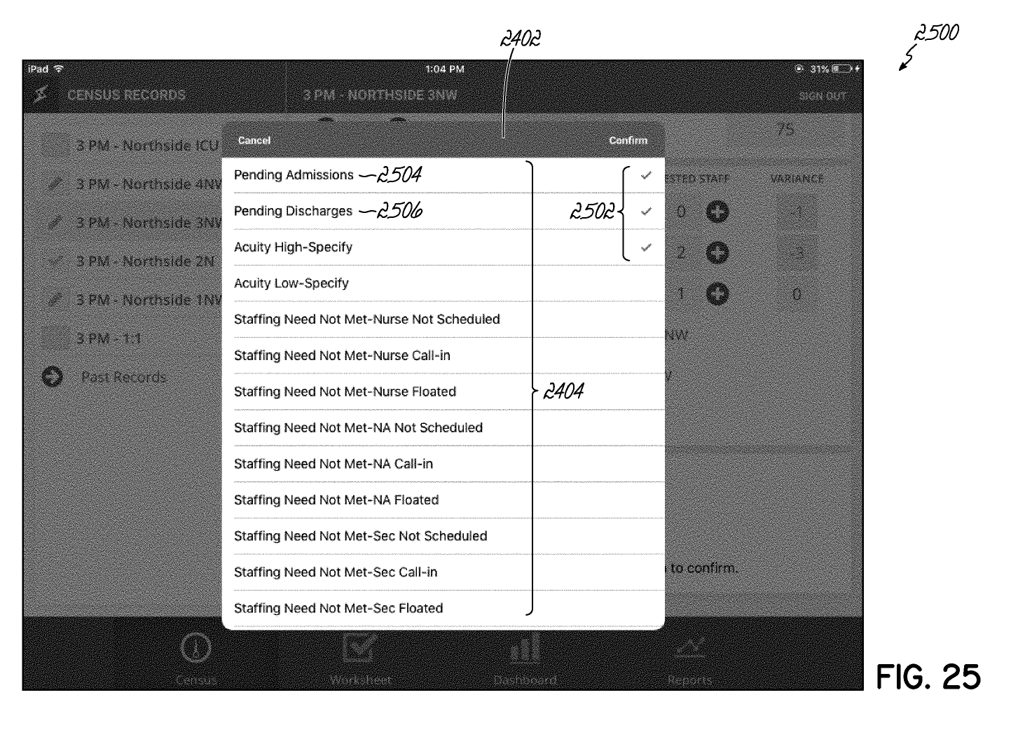

FIG. 23 is a schematic illustration 2300 of the census page showing a visual indicator 2302 that changes for the northside 3NW unit 2206, including non-zero variances, have been confirmed, according to an embodiment. In this example, the non-zero variances 2208 and 2210 have been confirmed. Available staff categories are also confirmed and indicated as “Actual Staff” as shown. In this example, the visual indicator 2302 is a check mark icon. In other embodiment, the system may be configured to show other visual indicators. Since it is generally undesirable to have non-zero variances, in further embodiments a utility is provided so that a user may indicate explanations why non-zero variances were deemed to be appropriate. The use of such a utility to provide explanations for non-zero variances is illustrated in FIGS. 24 and 25 and described in further detail below.

FIG. 24 is a schematic illustration 2400 of a utility having a pop-up window 2402 for specifying explanations for non-zero variances, according to an embodiment. The utility may be invoked from the census page. According to an embodiment, the pop-up window 2402 may be invoked at the time the confirm button 356 has been selected confirming non-zero variances. In this example, the pop-up window 2402 contains a list 2404 of user-selectable explanations that might account for why non-zero variances were deemed to be appropriate. The selection of explanations from the list 2404 is illustrated in FIG. 25 and discussed in further detail below.

FIG. 25 is a schematic illustration 2500 of the utility of FIG. 24 in which the pop-up window 2402 has been used to select reasons for non-zero variances, according to an embodiment. In this example, a list 2502 of explanations has been selected from the list 2402. By selecting explanations from the list, a user has a convenient way to specify reasons why non-zero variances were deemed to be appropriate. Such information may then be quickly conveyed to management. According to an embodiment, staffing information, including explanations for non-zero variances may be efficiently communicated to management personnel in the form of a “push notification” as would be readily understood by persons of ordinary skill in the relevant art.

In this example, one reason 2504 states “pending admissions.” As described above, it may be advantageous to have a positive variance if the patient census 314 (see FIG. 3) is expected to increase during a work shift. In such a situation, the positive variance indicates that more staff are available than are needed at the beginning of the shift, in anticipation that the number of patients (given by the patient census 314) will increase. In this example, a further reason 2506 states “pending discharges.” This reason would be selected to explain a negative variance. In such a situation, a negative variance would be deemed appropriate if the patient census 314 was expected to decrease during a work shift.

FIG. 26 is a schematic illustration 2600 of the dashboard page 2602 that provides a summary of schedule settings implemented on the census and worksheet pages, according to an embodiment. In this example, the dashboard page 2602 is invoked by selecting the dashboard button 206. The dashboard page 2602 illustrates settings for each personnel category. In this example, the information is provided in graphical form showing variances from guidelines in a first graph 2604 and showing guideline vs. actual hours in a second graph 2606. The information in each graph summarizes settings for personnel categories with respect to a plurality of employment units.

According to an embodiment, the first graph 2604 presents information for each category (i.e., charge, charge nurse, monitor tech, etc.) by presenting three metrics. A first metric indicates the number of employment units (telemetry, surgical, etc.) having a negative variance, or in other words, having a number of available staff that is below the corresponding suggested guideline number of staff. A second metric indicates the number of employment units having a number of available staff that is equal to the corresponding suggested guideline number. A third metric indicates the number of employment units having a number of available staff that is above the corresponding suggested guideline number.

In this example, in the graph 2604, the nurse 306 category has three horizontal bars as shown. A first bar 2606 has a horizontal length equal to 1. This indicates that for the nurse 306 category, there is one employment unit for which there is a negative variance (i.e., the available staff is below the guideline). Further, for the nurse 306 category, a second bar 2608 has a length equal to 5. This implies that for the nurse 306 category there are five employment units for which the number of available staff is equal to the corresponding suggested guideline number (i.e., the available staff is at the guideline). A third bar 2610, for the nurse 306 category, has horizontal length equal to 1. This indicates that there is one employment unit having a positive variance (i.e., the number of available staff is above the guideline) for the nurse 306 category.

As mentioned above, in general it is desirable to have zero variance for a given personnel category for each of the employment units. This situation is exemplified by the NA 308 category in graph 2604. In this example, there are no horizontal bars indicating positive or negative variance. In this example, the number 2611 having value 0.0 indicates that there are no employment units having a negative variance (i.e., available staff below the guideline). Similarly, the number 2612 having value 0.0 indicates that there are no employment units having a positive variance (i.e., available staff above the guideline). For the NA 308 category, the bar 2614 has length equal to 7. This implies that, for the NA 308 category, there are seven employment units that each has a number of available personnel equal to the suggested guideline number (i.e., available staff at the guideline).

Other data presented in graph 2604 may be interpreted similarly. For example, for the charge nurse 304 category, the bar 2616 having length equal to 4 implies that there are four employment units having a negative variance, while bar 2618 having length equal to 3 implies that there are three employment units having a zero variance.

The second graph 2606 summarizes worked hours for each employment unit measured in both hours and in terms of an equivalent dollar amount. For example, the number of hours H worked by an employee at an hourly compensation rate R leads to a dollar amount D=H*R associated with the number of hours worked. The guideline numbers of staff for each employment unit predict a certain dollar amount D_{g} associated with the suggested guideline numbers of staff personnel. Similarly, a certain dollar amount Dₐ is associated with the actual number of staff personnel that work a given shift. A comparison of D_{g} and Dₐ provides a valuable metric for use in planning and analyzing staffing budgets. Graph 2606 is a comparison of these two quantities.

In this example, the oncology 222 unit illustrates a situation in which the actual number of hours of scheduled staff is equal to the suggested guideline number of staff. In this example, bar 2620 is equal to 24, meaning that the guideline number of staff personnel, multiplied by hours worked, for the oncology 222 unit is 24 hours. In this example, the 24 hours corresponds to a dollar amount of $1,960. Similarly, the actual number of hours for the oncology 222 unit is also equal to 24 hours, corresponding to $1,960, as indicated by bar 2622.

In contrast, other employment units had staffing schedules exhibiting negative variances. For example, the surgical 214 unit had a suggested guideline number of hours equal to 96 (i.e., with a dollar value of $6588) as indicated by the bar 2624. In contrast, for the surgical 214 unit, the actual number of scheduled hours was equal to 84 (i.e., with a dollar value of $6,228), as indicated by the bar 2626. Graph 2606 also presents the total guideline 2628 and actual 2639 staff hours for all employment units, having values equal to 298 hrs ($21,064) and 258 hrs ($20,658), respectively.

FIG. 27 is a schematic illustration 2700 of the reports page 2702 that provides a summary of schedule settings implemented on the census and worksheet pages, according to an embodiment. The reports page is invoked when the reports button 208 is selected. The content of the reports page 2702 is similar to that of the dashboard page 2602 illustrated in FIG. 26. In this example, the reports page 2702 also includes a first graph 2704 and a second graph 2706. The graph 2704 shows variances from guidelines as was shown in graph 2604 and the interpretation of the data in graph 2704 is similar to that in graph 2604 (see FIG. 26). The reports page 2702 also includes a second graph 2706 that plots guideline vs. actual hours and the interpretation of the data in graph 2706 is similar to the interpretation of graph 2606. The reports page 2702, however, provides further functionality than is provided in the dashboard page 2602 (see FIG. 26).

According to an embodiment, the reports page 2702 provides a user with greater control over the data that is displayed in graphs 2704 and 2706. For example, a user may generate graphs 2704 and 2706 to include data for a specific, user-selectable date range using the date range utility 2708. Further, for the date range selected using the date range utility 2708, a user may select which days of the week to include for generation of graphs 2704 and 2706 using the days of the week utility 2710. Further, in addition to selecting a date range and a set of days of the week, a user may select particular work shifts or may include all shifts using the shift times utility 2712. Further, a user may select which employment units to include in the generated report using the units utility 2714.

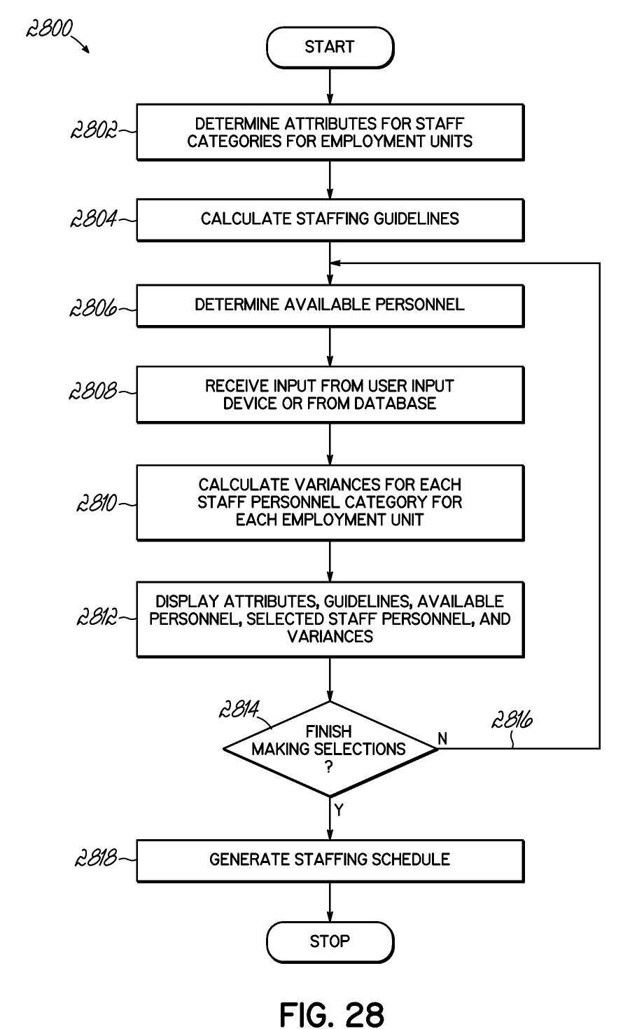

FIG. 28 is a flowchart 2800 illustrating the use of the invention and the method for management of variable staffing and productivity, according to an embodiment. According to an embodiment, the method is performed by a system including at least one processor, and a memory coupled to the processor. The memory may have computer program instructions stored thereon that, when executed by the processor, cause the processor to perform the operations of the method as illustrated, for example, in FIG. 28. In a first stage 2802, the instructions executed by the processor cause the processor to determine attributes for a plurality of employment units, each unit having a plurality of staff personnel categories. According to an embodiment, the attributes include a number and identity of persons assigned to each personnel category for each employment unit.

In a second stage 2804, the instructions executed by the processor cause the processor to calculate staffing guidelines comprising a suggested number of staff personnel for each personnel category for each employment unit. In a further stage 2806, the instructions executed by the processor cause the processor to determine a list of available personnel that may be assigned to personnel categories for each employment unit. In a further stage 2808, the instructions executed by the processor cause the processor to receive input from a user input device, the input designating a user selection of an employment unit and/or a designation of one or more persons assigned to a staff personnel category associated with a selected employment unit.

In a further stage 2810, the instructions executed by the processor cause the processor to calculate a variance for each staff personnel category associated with each employment unit, the variance representing a difference between a selected number of staff personnel and an available number of personnel or the variance representing a difference between a guideline number of staff personnel and an available number of personnel. In a further stage 2812, the instructions executed by the processor cause the processor to generate and display a graphical user interface on a display device, the graphical user interface displaying information comprising the attributes, guidelines, available personnel, selected staff personnel, and variances. According to an embodiment, the information may be presented on one or more user-selectable screens and/or menus that provide utilities for the information to be changed in response to user input.

Once a number of selections have been made, a test is performed in stage 2814 to determine if all selections have been made. If a user has not finished making selections, the method follows branch 2816 and returns control to stage 2806. In stage 2806 the method continues to allow a user to make further selections for additional staff personnel categories associated with other employment units. Control proceeds to stage 2818 when it is determined at stage 2814 that the user has finished making selections. At stage 2818, the instructions executed by the processor cause the processor to generate an employment staffing solution based on the attributes.

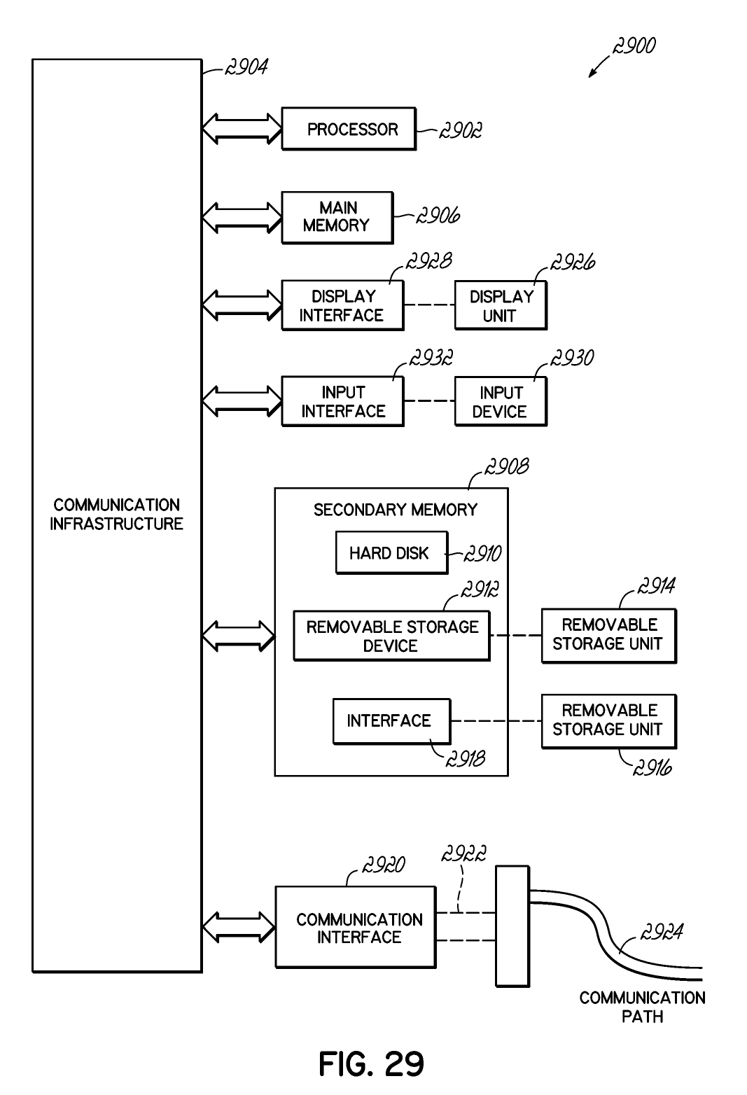

FIG. 29 is a block diagram of an example computer system 2900 in which embodiments of the disclosed invention, or portions thereof, may be implemented as computer-readable code, which is executed by one or more processors causing the one or more processors to perform operations of the disclosed invention, according to an embodiment.

For example, system 100 (see FIG. 1) may be implemented on computer system 2900 using hardware, software, firmware, tangible computer readable media having instructions stored thereon, or a combination thereof and may be implemented in one or more computer systems or other processing system.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

Various embodiments of the invention are described in terms of this example computer system 2900. After reading this description, it will become apparent to persons of ordinary skill in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons of ordinary skill in the relevant art, a computing device for implementing the disclosed invention has at least one processor, such as processor 2902, wherein the processor may be a single processor, a plurality of processors, a processor in a multi-core/multiprocessor system, such system operating alone, or in a cluster of computing devices operating in a cluster or server farm. Processor 2902 may be connected to a communication infrastructure 2904, for example, a bus, message queue, network, or multi-core message-passing scheme.

Computer system 2900 may also include a main memory 2906, for example, random access memory (RAM), and may also include a secondary memory 2908. Secondary memory 2908 may include, for example, a hard disk drive 2910, removable storage drive 2912. Removable storage drive 2912 may include a floppy disk drive, a magnetic tape drive, an optical disk drive, a flash memory, or the like. The removable storage drive 2912 may be configured to read and/or write data to a removable storage unit 2914 in a well-known manner. Removable storage unit 2914 may include a floppy disk, magnetic tape, optical disk, etc., which is read by and written to, by removable storage drive 2912. As will be appreciated by persons of ordinary skill in the relevant art, removable storage unit 2914 may include a computer readable storage medium having computer software (i.e., computer program instructions) and/or data stored thereon.

In alternative implementations, secondary memory 2908 may include other similar devices for allowing computer programs or other instructions to be loaded into computer system 2900. Such devices may include, for example, a removable storage unit 2916 and an interface 2918. Examples of such devices may include a program cartridge and cartridge interface (such as that found in video game devices), a removable memory chip (such as EPROM or PROM) and associated socket, and other removable storage units 2916 and interfaces 2918 which allow software and data to be transferred from the removable storage unit 2916 to computer system 2900.

Computer system 2900 may also include a communications interface 2920. Communications interface 2920 allows software and data to be transferred between computer system 2900 and external devices. Communications interfaces 2920 may include a modem, a network interface (such as an Ethernet card), a communications port, a PCMCIA slot and card, or the like. Software and data transferred via communications interface 2920 may be in the form of signals 2922, which may be electronic, electromagnetic, optical, or other signals capable of being received by communications interface 2920. These signals may be provided to communications interface 2920 via a communications path 2924.

In this document, the terms “computer program storage medium” and “computer usable storage medium” are used to generally refer to storage media such as removable storage unit 2914, removable storage unit 2916, and a hard disk installed in hard disk drive 2910. Computer program storage medium and computer usable storage medium may also refer to memories, such as main memory 2906 and secondary memory 2908, which may be semiconductor memories (e.g., DRAMS, etc.). Computer system 2900 may further include a display unit 2926 that interacts with communication infrastructure 2904 via a display interface 2928. Computer system 2900 may further include a user input device 2930 that interacts with communication infrastructure 2904 via an input interface 2932. A user input device 2930 may include a mouse, trackball, touch screen, or the like.

Computer programs (also called computer control logic or computer program instructions) are stored in main memory 2906 and/or secondary memory 2908. Computer programs may also be received via communications interface 2920. Such computer programs, when executed, enable computer system 2900 to implement embodiments as discussed herein. In particular, the computer programs, when executed, enable processor 2902 to implement the processes of embodiments of the invention, such as the stages in the method illustrated by flowchart 2800 of FIG. 28, discussed above. Accordingly, such computer programs represent controllers of the computer system 2900. When an embodiment is implemented using software, the software may be stored in a computer program product and loaded into computer system 2900 using removable storage drive 2912, interface 2918, and hard disk drive 2910, or communications interface 2920.

Embodiments may be implemented using software, hardware, and/or operating system implementations other than those described herein. Any software, hardware, and operating system implementations suitable for performing the functions described herein can be utilized. Embodiments are applicable to both a client and to a server or a combination of both.

### CONCLUSION

The Summary and Abstract sections may set forth one or more but not all example embodiments and thus are not intended to limit the scope of embodiments of the invention and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the invention that others can, by applying knowledge of those of ordinary skill in the art, readily modify and/or adapt for various applications such specific embodiments, without undue experimentation, without departing from the general concept of embodiments of the invention. Therefore, such adaptation and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the invention should not be limited by any of the above-described example embodiments, but should be defined only in accordance with the following claims and their equivalents.

What is claimed is:

1. A system for management of variable staffing, the system comprising:
at least one processor; and
a memory coupled to the processor, the memory having computer program instructions stored thereon that, when executed by the processor, cause the processor to:
determine attributes for a plurality of employment units, each unit having a plurality of staff personnel categories, and the attributes comprising a number and/or identity of persons assigned to each personnel category for each employment unit;
determine staffing guidelines comprising a suggested number of staff personnel for each personnel category for each employment unit;
selecting available personnel that may be assigned to personnel categories for each employment unit;
receive input designating a user selection of an employment unit and/or a designation of one or more persons from a list of available personnel to be assigned to a staff personnel category associated with a selected employment unit;
calculate a variance for each staff personnel category associated with each employment unit;
generate and display a graphical user interface on a display device, the graphical user interface displaying information comprising at least one of the attributes, guidelines, available personnel, selected staff personnel, and variances, and
wherein the information is presented on one or more user-selectable screens and/or menus that provide utilities for the information to be changed in response to user input.

2. The system according to claim 1, wherein the instructions, when executed by the processor, further cause the processor to generate and display the graphical user interface having a plurality of user-selectable pages including a census page, a worksheet page, a dashboard page, and a reports page.

3. The system according to claim 2, wherein the census page comprises:
a menu of user-selectable employment units;
a list of one or more personnel categories associated with a selected employment unit;
a list of guideline numbers of staff personnel suggested for each personnel category associated with the selected employment unit;
a list of numbers of available staff personnel for each personnel category associated with the selected employment unit;
a list of numbers of requested staff personnel for each personnel category associated with the selected employment unit;
a list of names of staff personnel that may be selected to change one or more numbers of available and requested staff personnel, and
wherein the variance is defined as a difference between a number of actual or available staff and a guideline number of staff.

4. The system according to claim 3, wherein the processor is further configured to:
receive a user selection of a name from the list of names of staff personnel displayed on the census page; and
calculate updated numbers of available and requested staff personnel displayed on the census page, in response to the user selection.

5. The system according to claim 3, wherein the processor is further configured to calculate values of the guideline numbers of staff personnel for a selected employment unit based on an anticipated workload.

6. The system according to claim 2, wherein the worksheet page comprises information similar to that provided on the census page in a scrollable screen format,
wherein a user may view information for a first employment unit in one configuration of the scrollable screen and then may change the configuration of the scrollable screen to view information for a second employment unit, a third employment unit, etc., and
wherein the variance is defined as a difference between a number of available and a number of requested staff.

7. The system according to claim 6, wherein the worksheet page further comprises a drag-and-drop utility that receives input from the user input device and increases or decreases a number of persons, assigned to a staff personnel category associated with a selected employment unit, in response to the received user input.

8. The system according to claim 6, wherein the worksheet page further comprises a menu of user-selectable descriptions providing standard explanations for user selections intentionally resulting in non-zero variances.

9. The system according to claim 2, wherein the dashboard page comprises graphical illustrations of variances as a function of staff personnel category and employment unit.

10. The system according to claim 2, wherein the reports page comprises a report generator utility that receives user selections of one or more parameters and generates a report characterizing the employment staffing solution based on the selected parameters,
wherein the parameters include one or more of: a date range, a range of days of the week, a range of shift times, and one or more employment units.

11. A method, performed by one or more processing devices, for generating an employment staffing solution, the method comprising:
determining attributes for a plurality of employment units, each unit having a plurality of staff personnel categories, and the attributes comprising a number and/or identity of persons assigned to each personnel category for each employment unit;
determining staffing guidelines comprising a suggested number of staff personnel for each personnel category for each employment unit;
selecting available personnel that may be assigned to personnel categories for each employment unit;
receiving input designating a user selection of an employment unit and/or a designation one or more persons assigned to a staff personnel category associated with a selected employment unit;
calculating a variance for each staff personnel category associated with each employment unit, the variance representing a difference between a guideline number of staff personnel and an available number of personnel;
generating and displaying a graphical user interface on a display device, the graphical user interface displaying information comprising at least one of the attributes, guidelines, available personnel, selected staff personnel, and variances, and
wherein the information is presented on one or more user-selectable screens and/or menus that provide utilities for the information to be changed in response to user input.

12. The method according to claim 11, further comprising generating and displaying the graphical user interface to comprise a plurality of user-selectable pages including a census page, a worksheet page, a dashboard page, and a reports page.

13. The method according to claim 12, further comprising generating and displaying the census page to comprise:
a menu of user-selectable employment units;
a list of one or more personnel categories associated with a selected employment unit;
a list of guideline numbers of staff personnel suggested for each personnel category associated with the selected employment unit;
a list of numbers of available staff personnel for each personnel category associated with the selected employment unit;
a list of numbers of requested staff personnel for each personnel category associated with the selected employment unit;
a list of names of staff personnel that may be selected to change one or more numbers of available and requested staff personnel, and
wherein the variance is defined as a difference between a number of actual or available staff and a guideline number of staff.

14. The method according to claim 13, further comprising:
receiving a user selection of a name from the list of names of staff personnel displayed on the census page; and
calculating updated numbers of available and requested staff personnel displayed on the census page, in response to the user selection.

15. The method according to claim 13, further comprising calculating values of the guideline numbers of staff personnel for a selected employment unit based on an anticipated workload.

16. The method according to claim 12, further comprising generating and displaying the worksheet page to comprise information similar to that provided on the census page in a scrollable screen format,
wherein a user may view information for a first employment unit in one configuration of the scrollable screen and then may change the configuration of the scrollable screen to view information for a second employment unit, a third employment unit, etc., and
wherein the variance is defined as a difference between a number of available and a number of requested staff.

17. The method according to claim 16, further comprising generating and displaying the worksheet page to further comprise a drag-and-drop utility that receives input from the user input device and increases or decreases a number of persons, assigned to a staff personnel category associated with a selected employment unit, in response to the received user input.

18. The method according to claim 16, further comprising generating and displaying the worksheet page to further comprise a menu of user-selectable descriptions providing standard explanations for user selections resulting in non-zero variances.

19. The method according to claim 12, further comprising generating and displaying the dashboard page to comprise graphical illustrations of variances as a function of staff personnel category and employment unit.

20. The method according to claim 12, further comprising generating and displaying the reports page to comprise a report generator utility that receives user selections of one or more parameters and generates a report characterizing the employment staffing solution based on the selected parameters,
wherein the parameters include one or more of: a date range, a range of days of the week, a range of shift times, and one or more employment units.
